(19) United States
(12) Patent Application Publication
(10) Pub. No.: US 2026/0205518 A1
(43) Pub. Date: Jul. 16, 2026

(54) ADAPTIVE WORKLOAD BALANCING FOR SPLIT EXTENDED REALITY (XR) SYSTEMS

(71) Applicant: QUALCOMM Incorporated, San Diego, CA (US)

(72) Inventors: Wesley James HOLLAND, Encinitas, CA (US); Kapil AHUJA, Bengaluru (IN); Pawan Kumar BAHETI, San Diego, CA (US); Manmohan MANOHARAN, Bengaluru (IN); Simon Peter William BOOTH, San Diego, CA (US); Rakesh Raju CHENNA MADHAVUNI, San Diego, CA (US); Dam BACKER, San Diego, CA (US); Vinay MELKOTE KRISHNAPRASAD, Bangalore (IN)

(21) Appl. No.: 19/471,662

(22) PCT Filed: Mar. 27, 2024
(86) PCT No.: PCT/US2024/021765

§ 371 Date: Oct. 1, 2025

(30) Foreign Application Priority Data
May 11, 2023 (IN) 202341033330

(51) Int. Cl. H04L 67/131; H04W 52/26

(52) U.S. Cl. CPC H04L 67/131; H04W 52/26

(57) ABSTRACT

Systems and techniques are provided for imaging. For example, a process can include determining estimated transmission power information associated with a channel between the apparatus and a computing device. The process can include obtaining one or more extended reality (XR) application parameters associated with an XR application corresponding to one or more of the apparatus or the computing device. The process can include determining, based on the estimated transmission power information and the one or more XR application parameters, a split perception configuration for balancing a perception workload of the XR application between the apparatus and the computing device.

### FIELD

The present disclosure generally relates to processing image data in an extended reality (XR) system. For example, aspects of the present disclosure are related to systems and techniques for dynamically balancing perception workloads and/or render workloads between an XR device and a companion device of a split-architecture XR system based on channel conditions.

### BACKGROUND

An extended reality (XR) (e.g., virtual reality (VR), augmented reality (AR), and/or mixed reality (MR)) system can provide a user with a virtual experience by displaying virtual content at a display mostly, or entirely, filling a user's field of view or by displaying virtual content overlaid onto, or alongside, a user's field of view of the real world (e.g., using a see-through or pass-through display).

XR systems typically include a display (e.g., a head-mounted display (HMD) or smart glasses), an image-capture device proximate to the display, and a processing device. In such XR systems, the image-capture device may capture images indicative of a field of view of user, the processing device may generate virtual content based on the field of view of the user, and the display may display the virtual content within the field of view of the user.

In some XR systems (e.g., split-architecture XR systems), the processing device may be separate from the display and/or image-capture device. For example, the processing device may be part of a companion device (e.g., a smartphone, a tablet, a laptop, a personal computer, or a server), while the display and image-capture device may be part of an XR device, such as an HMD, smart glasses, or other type of device.

In such split-architecture XR systems, the XR device may transmit image data (captured by the image-capture device) to the companion device and the companion device may determine or generate virtual-content data based on the image data. The companion device may then transmit the virtual-content data to the XR device for display using the display. It may be desirable to limit the size and/or quantity of the image data transmitted by the XR device to the companion device. Limiting the size of the transmitted data may conserve bandwidth available for communications between the XR device and the companion device. Bandwidth can be measured in terms of bitrate, which refers to a number of bits that can be transmitted during a given time (e.g., bits per second). Conserving bandwidth may conserve power (e.g., by transmitting less data) and/or may allow for other data to be transmitted using the conserved bandwidth.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, methods, apparatuses, and computer-readable media for processing image data. For example, the image data can be associated with an XR system and/or an XR processing workload. The systems and techniques can be used to provide adaptive (e.g., dynamic) splitting of one or more XR workloads between a first device and a second device. For example, the systems and techniques can be used to provide adaptive splitting of an XR perception workload and/or an XR rendering workload. The XR workload may be split between a first device comprising an XR device (e.g., an XR HMD, etc.) and a second device comprising a companion device (e.g., a UE, smartphone, user computing device, wearable device, etc.).

According to at least one illustrative example, a method of processing image data is provided, the method comprising: determining estimated transmission power information associated with a channel between an extended reality (XR) device and a companion device of the XR device, wherein the XR device and the companion device are included in a split-architecture XR system; obtaining one or more XR application parameters associated with an XR application corresponding to one or more of the XR device or the companion device; and determining, based on the estimated transmission power information and the one or more XR application parameters, a split perception configuration for balancing a perception workload of the XR application between the XR device and the companion device.

In another illustrative example, an apparatus for processing image data is provided. The apparatus includes at least one memory (e.g., configured to store data, such as image data, etc.) and one or more processors (e.g., implemented in circuitry) coupled to the at least one memory. The one or more processors are configured to and can: determine estimated transmission power information associated with a channel between the apparatus and a computing device; obtain one or more extended reality (XR) application parameters associated with an XR application corresponding to one or more of the apparatus or the computing device; and determine, based on the estimated transmission power information and the one or more XR application parameters, a split perception configuration for balancing a perception workload of the XR application between the apparatus and the computing device.

In another illustrative example, a non-transitory computer-readable medium is provided that has stored thereon instructions that, when executed by one or more processors, cause the one or more processors to: determine estimated transmission power information associated with a channel between an extended reality (XR) device and a companion device of the XR device, wherein the XR device and the companion device are included in a split-architecture XR system; obtain one or more XR application parameters associated with an XR application corresponding to one or more of the XR device or the companion device; and determine, based on the estimated transmission power information and the one or more XR application parameters, a split perception configuration for balancing a perception workload of the XR application between the XR device and the companion device.

In another illustrative example, an apparatus is provided. The apparatus includes: means for determining estimated transmission power information associated with a channel between the apparatus and a computing device; means for obtaining one or more extended reality (XR) application parameters associated with an XR application corresponding to one or more of the apparatus or the computing device; and means for determining, based on the estimated transmission power information and the one or more XR application parameters, a split perception configuration for balancing a perception workload of the XR application between the apparatus and the computing device.

According to another illustrative example, a method of processing image data is provided, the method comprising: determining channel condition information associated with a channel between an extended reality (XR) device and a companion device of the XR device, wherein the XR device and the companion device are included in a split-architecture XR system; obtaining one or more XR application parameters associated with an XR application corresponding to one or more of the XR device or the companion device; and determining, based on the channel condition information and the one or more XR application parameters, a render mode configuration for balancing a render workload of the XR application between the XR device and the companion device. In another illustrative example, an apparatus for processing image data is provided. The apparatus includes at least one memory (e.g., configured to store data, such as image data, etc.) and one or more processors (e.g., implemented in circuitry) coupled to the at least one memory. The one or more processors are configured to and can: determine channel condition information associated with a channel between the apparatus and a computing device; obtain one or more extended reality (XR) application parameters associated with an XR application corresponding to one or more of the apparatus or the computing device; and determine, based on the channel condition information and the one or more XR application parameters, a render mode configuration for balancing a render workload of the XR application between the apparatus and the computing device.

In another illustrative example, a non-transitory computer-readable medium is provided that has stored thereon instructions that, when executed by one or more processors, cause the one or more processors to: determine channel condition information associated with a channel between an extended reality (XR) device and a companion device of the XR device, wherein the XR device and the companion device are included in a split-architecture XR system; obtain one or more XR application parameters associated with an XR application corresponding to one or more of the XR device or the companion device; and determine, based on the channel condition information and the one or more XR application parameters, a render mode configuration for balancing a render workload of the XR application between the XR device and the companion device.

In another illustrative example, an apparatus is provided. The apparatus includes: means for determining channel condition information associated with a channel between the apparatus and a computing device; means for obtaining one or more extended reality (XR) application parameters associated with an XR application corresponding to one or more of the apparatus or the computing device; and means for determining, based on the channel condition information and the one or more XR application parameters, a render mode configuration for balancing a render workload of the XR application between the apparatus and the computing device.

In some aspects, one or more of the apparatuses described herein is, can be part of, or can include a mobile device (e.g., a mobile telephone or so-called “smart phone”, a tablet computer, or other type of mobile device), an extended reality device (e.g., a virtual reality (VR) device, an augmented reality (AR) device, or a mixed reality (MR) device), a vehicle (or a computing device or system of a vehicle), a smart or connected device (e.g., an Internet-of-Things (IOT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1A is a diagram illustrating an example of an extended reality (XR) system, in accordance with some examples;

FIG. 1B is a perspective diagram illustrating a head-mounted display (HMD), in accordance with some examples;

FIG. 1C is a perspective diagram illustrating the head-mounted display (HMD) of FIG. 1B being worn by a user, in accordance with some examples;

FIG. 2 is a diagram illustrating an architecture of an example XR system, in accordance with some examples;

FIG. 3 is a block diagram illustrating another example XR system, in accordance with some examples;

FIG. 4 is a block diagram illustrating an example of a split-architecture XR system including an XR HMD and a companion device, in accordance with some examples;

FIG. 5 is a block diagram illustrating an example of a split-architecture XR system including a perception mode adaptation engine that can be used to balance XR perception workload processing between an XR HMD and a companion device of the split-architecture XR system, in accordance with some examples;

FIG. 6 is a block diagram illustrating an example of a split-architecture XR system including a render mode adaptation engine that can be used to balance XR render workload processing between an XR HMD and a companion device of the split-architecture XR system, in accordance with some examples;

FIG. 7 is a flow diagram illustrating a process for processing image data, in accordance with some examples;

FIG. 8 is a flow diagram illustrating another process for processing image data, in accordance with some examples; and

FIG. 9 is a diagram illustrating an example of a computing system for implementing certain aspects described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Extended reality (XR) systems or devices can provide virtual content to a user and/or can combine real-world or physical environments and virtual environments (made up of virtual content) to provide users with XR experiences. The real-world environment can include real-world objects (also referred to as physical objects), such as people, vehicles, buildings, tables, chairs, and/or other real-world or physical objects. XR systems or devices can facilitate interaction with different types of XR environments (e.g., a user can use an XR system or device to interact with an XR environment). XR systems can include virtual reality (VR) systems facilitating interactions with VR environments, augmented reality (AR) systems facilitating interactions with AR environments, mixed reality (MR) systems facilitating interactions with MR environments, and/or other XR systems. Examples of XR systems or devices include head-mounted displays (HMDs), smart glasses, among others. In some cases, an XR system can track parts of the user (e.g., a hand and/or fingertips of a user) to allow the user to interact with items of virtual content.

AR is a technology that provides virtual or computer-generated content (referred to as AR content) superimposed over the user's view of a physical, real-world scene or environment. AR content can include virtual content, such as video, images, graphic content, plaintext, location data (e.g., global positioning system (GPS) data or other location data), sounds, any combination thereof, and/or other augmented content. An AR system or device is designed to enhance (or augment), rather than to replace, a person's current perception of reality. For example, a user can see a real stationary or moving physical object through an AR device display, but the user's visual perception of the physical object may be augmented or enhanced by a virtual image of that object (e.g., a real-world car replaced by a virtual image of a DeLorean), by AR content added to the physical object (e.g., virtual wings added to a live animal), by AR content displayed relative to the physical object (e.g., informational virtual content displayed near a sign on a building, a virtual coffee cup virtually anchored to (e.g., placed on top of) a real-world table in one or more images, etc.), and/or by displaying other types of AR content. Various types of AR systems can be used for gaming, entertainment, and/or other applications.

In some cases, an XR system can include an optical “see-through” or “pass-through” display (e.g., see-through or pass-through AR HMD or AR glasses), allowing the XR system to display XR content (e.g., AR content) directly onto a real-world view without displaying video content. For example, a user may view physical objects through a display (e.g., glasses or lenses), and the AR system can display AR content onto the display to provide the user with an enhanced visual perception of one or more real-world objects. In one example, a display of an optical see-through AR system can include a lens or glass in front of each eye (or a single lens or glass over both eyes). The see-through display can allow the user to see a real-world or physical object directly, and can display (e.g., projected or otherwise displayed) an enhanced image of that object or additional AR content to augment the user's visual perception of the real world (e.g., such as the inside of a building or machine). In some cases, an XR system may allow a user to interact with an environment around the XR system.

Some XR systems may employ computer-vision and/or perception processes which may include detection algorithms, recognition algorithms, and/or tracking algorithms. For example, a computer-vision process may receive images, detect (and/or recognize) real-world objects (e.g., people, hands, vehicles, etc.) in the images, and track the real-world objects in the images.

In some cases, when XR systems (including split-architecture XR systems) implement computer-vision and/or perception processes, most, or all, of the computer-vision and/or perception processes are implemented at a companion device of the XR system and not in an XR device of the XR system. For example, the XR device may capture images and provide the captured images to the companion device which may implement detection, recognition, and/or tracking algorithms, among various others. As noted above, in split-architecture XR systems, there may be a need to limit the size of the image data transmitted by an XR device to a companion device, for example, to limit power consumption of the XR device and/or to conserve bandwidth for other purposes.

Detection and/or recognition algorithms may operate on full images to detect real-world objects within the images. Tracking algorithms may focus on and/or utilize only portions of the images representative of the real-world objects. For example, a tracking algorithm may operate using pixels of a frame of image data that are within a bounding box corresponding a real-world object to be tracked, and does not utilize (e.g., or require) the pixels of the frame of image data are outside of the bounding box. As used herein, the term “bounding box” may refer to a number of image pixels surrounding and including an object represented in the image pixels. An object-detection or object tracking algorithm may be used to determine and/or generate a bounding box around an object represented in the plurality of pixels of a frame of image data.

In some examples, the size of transmissions between an XR device and a companion device of an XR system can be reduced based on implementing a split-architecture XR system. A split-architecture XR system can be configured to balance various XR workloads and/or XR processing tasks between an XR device (e.g., HMD, smart glasses, etc.) and a companion device associated with the XR device (e.g., a smartphone, desktop computer, other computing device(s), etc.).

As used herein, a split-architecture XR system may also be referred to as a split XR system, a split processing XR system, etc. The split-architecture XR system may include an XR device (e.g., such as an XR HMD, etc.) and a companion device associated with the XR device. The XR device of a split-architecture XR system may also be referred to as a split XR HMD. The companion device of a split-architecture XR system may also be referred to as a split XR companion device.

In some aspects, various XR HMDs and/or other wearable devices may utilize a relatively small form-factor and/or may have a relatively small physical size (e.g., based on factors such as fashion, comfort, wearability, etc.). The relatively small form-factor design of XR HMDs can be associated with thermal constraints that are challenging to manage and overcome. Based at least in part on these thermal constraints, one approach to reducing power (e.g., and reducing thermal effects) in an XR HMD is to split processing between the HMD and a companion device, such as a puck or smartphone.

Systems, apparatuses, methods (also referred to as processes), and computer-readable media (collectively referred to herein as “systems and techniques”) are described herein for processing image data in a split-architecture XR system. For example, the systems and techniques can be used to provide adaptive workload (e.g., XR processing workloads, etc.) balancing between an XR HMD and a companion device of the split-architecture XR system. In one illustrative example, the systems and techniques can implement adaptive balancing of XR perception workload processing between the XR HMD and the companion device of the split-architecture XR system. In some aspects, the systems and techniques can implement adaptive balancing of XR render workload processing between the XR HMD and the companion device of the split-architecture XR system. In some examples, the adaptive balancing of the XR perception workload processing and/or the XR render workload processing can be based on channel condition information, where the channel condition information corresponds to one or more wireless channels between the XR HMD and the companion device of the split-architecture XR system.

In some aspects, the systems and techniques can be used to implement adaptive split perception to dynamically balance an XR perception processing workload between an XR HMD and a companion device of a split-architecture XR system. For example, the adaptive split perception can be implemented for XR HMDs and/or companion devices of split-architecture XR systems, based on channel condition information corresponding to one or more wireless channels between the XR HMD and the companion device of a split XR system. For example, the XR HMD and/or the companion device can determine channel condition information corresponding to a channel between the XR HMD and the companion device. The channel condition information can be WiFi channel condition information, and may be indicative of a modulation coding scheme (MCS) associated with and/or used for communications on the channel. The XR HMD (or the companion device) can determine estimated transmission power information for a transmission over the channel, based on the current channel condition information. For example, the power required to transmit data for offloading one or more perception processing tasks from the XR HMD to the companion device can be estimated based on the current channel conditions. Based on the estimated transmission power, a split perception configuration can be selected from a plurality of split perception configurations for balancing a perception workload of an XR application between the XR HMD and the companion device. For example, in relatively clear channel conditions, the estimated power for offloading perception tasks from the XR HMD to the companion device can be relatively low (e.g., the power to encode, transmit, and decode the corresponding data at the XR HMD is less than the power to process and render the corresponding data at the XR HMD without offloading to the companion device).

In another illustrative example, the systems and techniques can be used to perform channel-adaptive rendering in split XR systems (e.g., split-architecture XR systems that include an XR HMD and a companion device). For example, the channel-adaptive rendering can be implemented to dynamically balance an XR rendering workload between an XR HMD and a companion device of a split XR system, where the XR rendering workload is dynamically balanced based on channel condition information corresponding to one or more wireless channels associated with the split XR system. In some aspects, the channel condition information can correspond to a channel between the XR HMD and the companion device. The channel condition information can be WiFi channel condition information, and may be indicative of a modulation coding scheme (MCS) associated with and/or used for communications on the channel. Based on the channel condition information, a render mode configuration can be selected from a plurality of render mode configurations for balancing a render workload of an XR application between the XR HMD and the companion device. For example, a different render mode configuration can be selected corresponding to different channel condition states (e.g., clear, moderate, poor, etc., channel conditions). A clear channel condition state can correspond to selecting a render mode configuration where world-locked and head-locked layers are rendered and composited on the companion device, and sent to the XR HMD for reprojection or warping (e.g., late-stage reprojection (LSR)). A moderate channel condition state can correspond to selecting a render mode configuration where the head-locked layers (e.g., most noticeable to the user of the XR HMD) are rendered locally by the XR HMD, while the world-locked layers are rendered on the companion device. The XR HMD can subsequently composite the locally-rendered head-locked layers and the rendered world-locked layers from the companion device. A poor channel condition state can correspond to selecting a render mode configuration that is the same as or similar to the moderate channel condition render mode described above, but with the world-locked renders from the companion device being further downscaled prior to transmission to the XR HMD. The XR HMD can then upscale (e.g., super-resolve) the downscaled world-locked renders prior to compositing the re-scaled world-locked renders with the locally-rendered head-locked layers.

Further aspects of the systems and techniques will be described with reference to the figures.

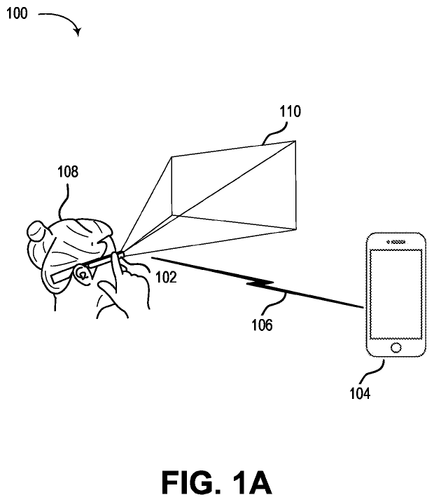

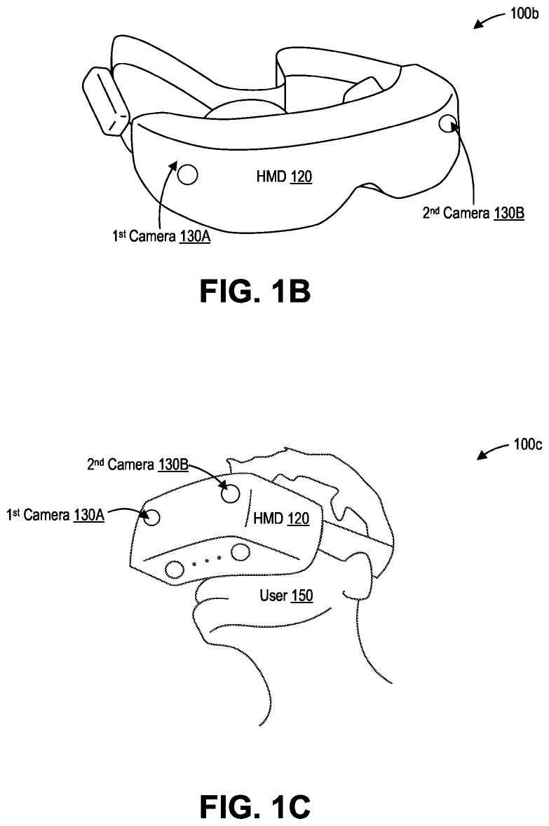

FIG. 1A is a diagram illustrating an example of an extended reality (XR) system 100, in accordance with some examples. As shown, XR system 100 includes an XR device 102, a companion device 104, and a communication link 106 between XR device 102 and companion device 104. In some cases, XR device 102 may generally implement display, image-capture, and/or view-tracking aspects of extended reality, including virtual reality (VR), augmented reality (AR), mixed reality (MR), etc. In some cases, companion device 104 may generally implement computing aspects of extended reality. For example, XR device 102 may capture images of an environment of a user 108 and provide the images to companion device 104 (e.g., via communication link 106). Companion device 104 may render virtual content (e.g., related to the captured images of the environment) and provide the virtual content to XR device 102 (e.g., via communication link 106). XR device 102 may display the virtual content to a user 108 (e.g., within a field of view 110 of user 108).

Generally, XR device 102 may display virtual content to be viewed by a user 108 in field of view 110. In some examples, XR device 102 may include a transparent surface (e.g., optical glass) such that virtual objects may be displayed on (e.g., by being generated at or projected onto) the transparent surface to overlay virtual content on real-word objects viewed through the transparent surface (e.g., in a see-through configuration). In some cases, XR device 102 may include a camera and may display both real-world objects (e.g., as frames or images captured by the camera) and virtual objects overlaid on the displayed real-world objects (e.g., in a pass-through configuration). In various examples, XR device 102 may include aspects of a virtual reality headset, smart glasses, a live feed video camera, a GPU, one or more sensors (e.g., such as one or more inertial measurement units (IMUs), image sensors, microphones, etc.), one or more output devices (e.g., such as speakers, display, smart glass, etc.), etc.

Companion device 104 may render the virtual content to be displayed by companion device 104. In some examples, companion device 104 may be, or may include, a smartphone, laptop, tablet computer, personal computer, gaming system, a server computer or server device (e.g., an edge or cloud-based server, a personal computer acting as a server device, or a mobile device acting as a server device), any other computing device and/or a combination thereof.

Communication link 106 may be a wired or wireless connection according to any suitable wireless protocol, such as, for example, universal serial bus (USB), ultra-wideband (UWB), Institute of Electrical and Electronics Engineers (IEEE) 802.11 (Wi-Fi), IEEE 802.15, or Bluetooth®. In some cases, communication link 106 may be a direct wireless connection between XR device 102 and companion device 104. In other cases, communication link 106 may be through one or more intermediary devices, such as, for example, routers or switches and/or across a network.

According to various aspects, XR device 102 may capture images and provide the captured images to companion device 104. Companion device 104 may implement detection, recognition, and/or tracking algorithms based on the captured images.

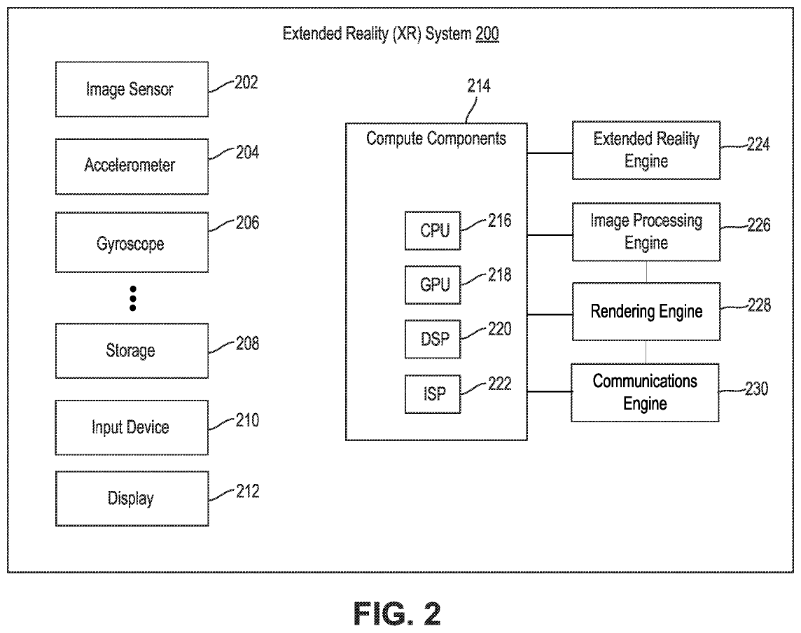

FIG. 1B is a perspective diagram 100b illustrating a head-mounted display (HMD) 120, in accordance with some examples. The HMD 120 may be, for example, an augmented reality (AR) headset, a virtual reality (VR) headset, a mixed reality (MR) headset, an extended reality (XR) headset, or some combination thereof. The HMD 120 may be an example of an XR system, such as the XR system 200 of FIG. 2. The HMD 120 includes a first camera 130A and a second camera 130B along a front portion of the HMD 120. In some examples, the HMD 120 may only have a single camera. In some examples, the HMD 120 may include one or more additional cameras in addition to the first camera 130A and the second camera 130B. In some examples, the HMD 120 may include one or more additional sensors in addition to the first camera 130A and the second camera 130B.

FIG. 1C is a perspective diagram 100c illustrating the head-mounted display (HMD) 120 of FIG. 1B being worn by a user 150, in accordance with some examples. The user 150 wears the HMD 120 on the user 150's head over the user 150's eyes. The HMD 120 can capture images with the first camera 130A and the second camera 130B. In some examples, the HMD 120 displays one or more display images toward the user 150's eyes that are based on the images captured by the first camera 130A and the second camera 130B. The display images may provide a stereoscopic view of the environment, in some cases with information overlaid and/or with other modifications. For example, the HMD 120 can display a first display image to the user 150's right eye, the first display image based on an image captured by the first camera 130A. The HMD 120 can display a second display image to the user 150's left eye, the second display image based on an image captured by the second camera 130B. For example, the HMD 120 may provide overlaid information in the display images overlaid over the images captured by the first camera 130A and the second camera 130B.

The HMD 120 may include no wheels, propellers or other conveyance of its own. Instead, the HMD 120 relies on the movements of the user 150 to move the HMD 120 about the environment. In some cases, for example where the HMD 120 is a VR headset, the environment may be entirely or partially virtual. If the environment is at least partially virtual, then movement through the virtual environment may be virtual as well. For example, movement through the virtual environment can be controlled by an input device. The movement actuator may include any such input device. Movement through the virtual environment may not require wheels, propellers, legs, or any other form of conveyance. In some cases, feature tracking and/or SLAM may be performed in a virtual environment even by a vehicle or other device that has its own physical conveyance system that allows it to physically move about a physical environment.

FIG. 2 is a diagram illustrating an architecture of an example extended reality (XR) system 200, in accordance with some examples. XR system 200 may execute XR applications and implement XR operations. In this illustrative example, XR system 200 includes one or more image sensors 202, an accelerometer 204, a gyroscope 206, storage 208, an input device 207, a display 212, compute components 214, an XR engine 224, an image processing engine 226, a rendering engine 228, and a communications engine 230. It should be noted that the components 202-230 shown in FIG. 2 are non-limiting examples provided for illustrative and explanation purposes, and other examples may include more, fewer, or different components than those shown in FIG. 2. For example, in some cases, XR system 200 may include one or more other sensors (e.g., one or more inertial measurement units (IMUs), radars, light detection and ranging (LIDAR) sensors, radio detection and ranging (RADAR) sensors, sound detection and ranging (SODAR) sensors, sound navigation and ranging (SONAR) sensors. audio sensors, etc.), one or more display devices, one more other processing engines, one or more other hardware components, and/or one or more other software and/or hardware components that are not shown in FIG. 2. While various components of XR system 200, such as image sensor 202, may be referenced in the singular form herein, it should be understood that XR system 200 may include multiple of any component discussed herein (e.g., multiple image sensors 202).

Display 212 may be, or may include, a glass, a screen, a lens, a projector, and/or other display mechanism that allows a user to see the real-world environment and also allows XR content to be overlaid, overlapped, blended with, or otherwise displayed thereon.

XR system 200 may include, or may be in communication with, (wired or wirelessly) an input device 210. Input device 210 may include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device discussed herein, or any combination thereof. In some cases, image sensor 202 may capture images that may be processed for interpreting gesture commands.

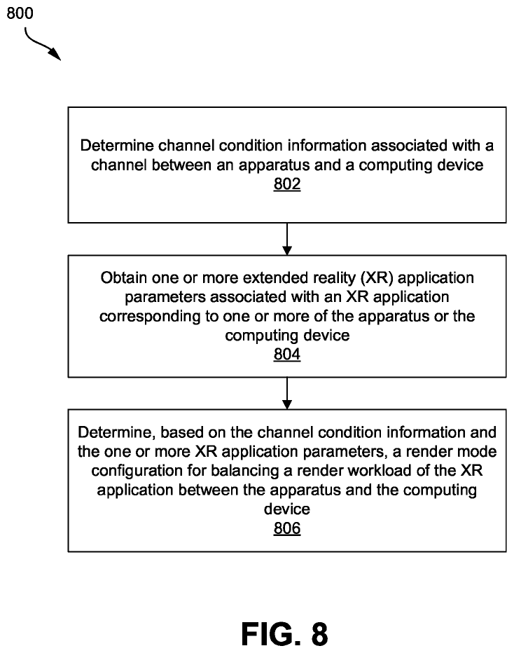

XR system 200 may also communicate with one or more other electronic devices (wired or wirelessly). For example, communications engine 230 may be configured to manage connections and communicate with one or more electronic devices. In some cases, communications engine 230 may correspond to communication interface 840 of FIG. 8.

In some implementations, image sensors 202, accelerometer 204, gyroscope 206, storage 208, display 212, compute components 214, XR engine 224, image processing engine 226, and rendering engine 228 may be part of the same device. For example, in some cases, image sensors 202, accelerometer 204, gyroscope 206, storage 208, display 212, compute components 214, XR engine 224, image processing engine 226, and rendering engine 228 may be integrated into an HMD, extended reality glasses, smartphone, laptop, tablet computer, gaming system, and/or any other computing device. However, in some implementations, image sensors 202, accelerometer 204, gyroscope 206, storage 208, display 212, compute components 214, XR engine 224, image processing engine 226, and rendering engine 228 may be part of two or more separate computing devices. For example, in some cases, some of the components 202-230 may be part of, or implemented by, one computing device and the remaining components may be part of, or implemented by, one or more other computing devices. For example, such as in a split perception XR system, XR system 200 may include a first device (e.g., an XR device such as XR device 102 of FIG. 1A, HMD 120 of FIGS. 1B and 1C, etc.), including display 212, image sensor 202, accelerometer 204, gyroscope 206, and/or one or more compute components 214. XR system 200 may also include a second device including additional compute components 214 (e.g., implementing XR engine 224, image processing engine 226, rendering engine 228, and/or communications engine 230). In such an example, the second device may generate virtual content based on information or data (e.g., images, sensor data such as measurements from accelerometer 204 and gyroscope 206) and may provide the virtual content to the first device for display at the first device. The second device may be, or may include, a smartphone, laptop, tablet computer, personal computer, gaming system, a server computer or server device (e.g., an edge or cloud-based server, a personal computer acting as a server device, or a mobile device acting as a server device), any other computing device and/or a combination thereof.

Storage 208 may be any storage device(s) for storing data. Moreover, storage 208 may store data from any of the components of XR system 200. For example, storage 208 may store data from image sensor 202 (e.g., image or video data), data from accelerometer 204 (e.g., measurements), data from gyroscope 206 (e.g., measurements), data from compute components 214 (e.g., processing parameters, preferences, virtual content, rendering content, scene maps, tracking and localization data, object detection data, privacy data, XR application data, face recognition data, occlusion data, etc.), data from XR engine 224, data from image processing engine 226, and/or data from rendering engine 228 (e.g., output frames). In some examples, storage 208 may include a buffer for storing frames for processing by compute components 214.

Compute components 214 may be, or may include, a central processing unit (CPU) 216, a graphics processing unit (GPU) 218, a digital signal processor (DSP) 220, an image signal processor (ISP) 222, and/or other processor (e.g., a neural processing unit (NPU) implementing one or more trained neural networks). Compute components 214 may perform various operations such as image enhancement, computer vision, graphics rendering, extended reality operations (e.g., tracking, localization, pose estimation, mapping, content anchoring, content rendering, predicting, etc.), image and/or video processing, sensor processing, recognition (e.g., text recognition, facial recognition, object recognition, feature recognition, tracking or pattern recognition, scene recognition, occlusion detection, etc.), trained machine-learning operations, filtering, and/or any of the various operations described herein. In some examples, compute components 214 may implement (e.g., control, operate, etc.) XR engine 224, image processing engine 226, and rendering engine 228. In other examples, compute components 214 may also implement one or more other processing engines.

Image sensor 202 may include any image and/or video sensors or capturing devices. In some examples, image sensor 202 may be part of a multiple-camera assembly, such as a dual-camera assembly. Image sensor 202 may capture image and/or video content (e.g., raw image and/or video data), which may then be processed by compute components 214, XR engine 224, image processing engine 226, and/or rendering engine 228 as described herein.

In some examples, image sensor 202 may capture image data and may generate images (also referred to as frames) based on the image data and/or may provide the image data or frames to XR engine 224, image processing engine 226, and/or rendering engine 228 for processing. An image or frame may include a video frame of a video sequence or a still image. An image or frame may include a pixel array representing a scene. For example, an image may be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, image sensor 202 (and/or other camera of XR system 200) may be configured to also capture depth information. For example, in some implementations, image sensor 202 (and/or other camera) may include an RGB-depth (RGB-D) camera. In some cases, XR system 200 may include one or more depth sensors (not shown) that are separate from image sensor 202 (and/or other camera) and that may capture depth information. For example, such a depth sensor may obtain depth information independently from image sensor 202. In some examples, a depth sensor may be physically installed in the same general location or position as image sensor 202, but may operate at a different frequency or frame rate from image sensor 202. In some examples, a depth sensor may take the form of a light source that may project a structured or textured light pattern, which may include one or more narrow bands of light, onto one or more objects in a scene. Depth information may then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

XR system 200 may also include other sensors in its one or more sensors. The one or more sensors may include one or more accelerometers (e.g., accelerometer 204), one or more gyroscopes (e.g., gyroscope 206), and/or other sensors. The one or more sensors may provide velocity, orientation, and/or other position-related information to compute components 214. For example, accelerometer 204 may detect acceleration by XR system 200 and may generate acceleration measurements based on the detected acceleration. In some cases, accelerometer 204 may provide one or more translational vectors (e.g., up/down, left/right, forward/back) that may be used for determining a position or pose of XR system 200. Gyroscope 206 may detect and measure the orientation and angular velocity of XR system 200. For example, gyroscope 206 may be used to measure the pitch, roll, and yaw of XR system 200. In some cases, gyroscope 206 may provide one or more rotational vectors (e.g., pitch, yaw, roll). In some examples, image sensor 202 and/or XR engine 224 may use measurements obtained by accelerometer 204 (e.g., one or more translational vectors) and/or gyroscope 206 (e.g., one or more rotational vectors) to calculate the pose of XR system 200. As previously noted, in other examples, XR system 200 may also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors may include at least one IMU. An IMU is an electronic device that measures the specific force, angular rate, and/or the orientation of XR system 200, using a combination of one or more accelerometers, one or more gyroscopes, and/or one or more magnetometers. In some examples, the one or more sensors may output measured information associated with the capture of an image captured by image sensor 202 (and/or other camera of XR system 200) and/or depth information obtained using one or more depth sensors of XR system 200.

The output of one or more sensors (e.g., accelerometer 204, gyroscope 206, one or more IMUs, and/or other sensors) can be used by XR engine 224 to determine a pose of XR system 200 (also referred to as the head pose) and/or the pose of image sensor 202 (or other camera of XR system 200). In some cases, the pose of XR system 200 and the pose of image sensor 202 (or other camera) can be the same. The pose of image sensor 202 refers to the position and orientation of image sensor 202 relative to a frame of reference (e.g., with respect to a field of view 110 of FIG. 1A). In some implementations, the camera pose can be determined for 6-Degrees Of Freedom (6DoF), which refers to three translational components (e.g., which can be given by X (horizontal), Y (vertical), and Z (depth) coordinates relative to a frame of reference, such as the image plane) and three angular components (e.g., roll, pitch, and yaw relative to the same frame of reference). In some implementations, the camera pose can be determined for 3-Degrees Of Freedom (3DoF), which refers to the three angular components (e.g., roll, pitch, and yaw).

In some cases, a device tracker (not shown) can use the measurements from the one or more sensors and image data from image sensor 202 to track a pose (e.g., a 6DoF pose) of XR system 200. For example, the device tracker can fuse visual data (e.g., using a visual tracking solution) from the image data with inertial data from the measurements to determine a position and motion of XR system 200 relative to the physical world (e.g., the scene) and a map of the physical world. As described below, in some examples, when tracking the pose of XR system 200, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of XR system 200 within the scene and the 3D map of the scene, etc. The 3D map can provide a digital representation of a scene in the real/physical world. In some examples, the 3D map can anchor position-based objects and/or content to real-world coordinates and/or objects. XR system 200 can use a mapped scene (e.g., a scene in the physical world represented by, and/or associated with, a 3D map) to merge the physical and virtual worlds and/or merge virtual content or objects with the physical environment.

In some aspects, the pose of image sensor 202 and/or XR system 200 as a whole can be determined and/or tracked by compute components 214 using a visual tracking solution based on images captured by image sensor 202 (and/or other camera of XR system 200). For instance, in some examples, compute components 214 can perform tracking using computer vision-based tracking, model-based tracking, and/or simultaneous localization and mapping (SLAM) techniques. For example, compute components 214 can perform SLAM or can be in communication (wired or wireless) with a SLAM system (not shown). SLAM refers to a class of techniques where a map of an environment (e.g., a map of an environment being modeled by XR system 200) is created while simultaneously tracking the pose of a camera (e.g., image sensor 202) and/or XR system 200 relative to that map. The map can be referred to as a SLAM map and can be three-dimensional (3D). The SLAM techniques can be performed using color or grayscale image data captured by image sensor 202 (and/or other camera of XR system 200) and can be used to generate estimates of 6DoF pose measurements of image sensor 202 and/or XR system 200. Such a SLAM technique configured to perform 6DoF tracking can be referred to as 6DoF SLAM. In some cases, the output of the one or more sensors (e.g., accelerometer 204, gyroscope 206, one or more IMUs, and/or other sensors) can be used to estimate, correct, and/or otherwise adjust the estimated pose.

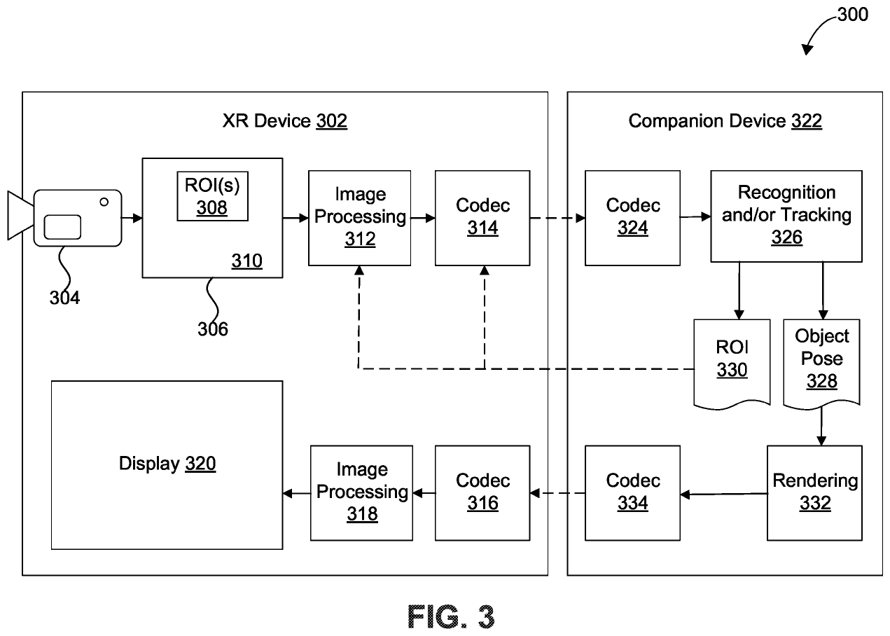

FIG. 3 is a block diagram illustrating an example extended reality (XR) system 300, in accordance with some examples. XR system 300 may include an XR device 302 and a companion device 322. XR device 302 may be a head-borne device (e.g., an HMD, smart glasses, or the like). XR device 302 may be an example of XR device 102 of FIG. 1A, HMD 120 of FIGS. 1B and 1C, etc. Companion device 322 may be, may be included in, or may be implemented in a computing device, such as a mobile phone, a tablet, a laptop, a personal computer, a server, a computing system of a vehicle, or other computing device. Companion device 322 may be an example of companion device 104 of FIG. 1A.

The XR device 302 includes an image-capture device 304 that may capture one or more images 306 (e.g., the image-capture device may capture image(s) 306 continuously). Image(s) 306 may be, or may include, single-view images (e.g., monocular images) or multi-view images (e.g., stereoscopically paired images). Image(s) 306 may include one or more regions of interest (ROIs) 308 and one more non-region-of-interest portions 310. When image(s) 306 are captured, XR device 302 may, or may not, distinguish between region(s) of interest 308 and non-region-of-interest portion(s) 310. According to a first example, XR device 302 may identify region(s) of interest 308 (e.g., based on a gaze of the user based on images captured by another camera directed towards the eyes of the user (not illustrated in FIG. 3)). According to a second example, companion device 322 may identify region(s) of interest 308 within image(s) 306 according to one or more techniques (as will be described with more detail below) and provide ROI information 330 indicative of region(s) of interest 308 to XR device 302. XR device 302 may parse newly-captured image(s) 306 according to region(s) of interest 308 determined by companion device 322 based on previously-captured image(s) 306. For example, XR device 302 may identify pixels in the newly-captured image(s) 306 that correlate to the region(s) of interest 308 identified based on previously-captured image(s) 306.

XR device 302 may process image(s) 306 at an image-processing engine 312. Image-processing engine 312 may be a circuit or a chip (e.g., a field-programmable gate array (FPGA) or an image processor). Image-processing engine 312 may, among other things, filter image(s) 306 (e.g., to remove noise). In some cases, image-processing engine 312 may receive ROI information 330 and apply a low-pass filter to non-region-of-interest portion(s) 310 of image(s) 306. Applying the low-pass filter may remove high-frequency spatial content from the image data which may allow the image data to be encoded (e.g., by an encoder 314) using fewer bits per pixel. Applying a low-pass filter to an image may have the effect of blurring the image. Because the low-pass filter is applied to non-region-of-interest portion(s) 310, and not to region(s) of interest 308, companion device 322 may not be impaired in its ability to detect, recognize, and/or track objects in region(s) of interest 308 of image(s) 306.

Image-processing engine 312 may provide processed image data to encoder 314 (which may be a combined encoding-decoding device, also referred to as a codec). Encoder 314 may be, or may implemented in, a circuit or a chip (e.g., an FPGA or a processor). Encoder 314 may encode the processed image data for transmission (e.g., as individual data packets for sequential transmission). In one illustrative example, encoder 314 can encode the image data based on a video coding standard, such as High-Efficiency Video Coding (HEVC), Versatile Video Coding (VVC), or another video coding standard. In another illustrative example, encoder 314 can encode the image data using a machine-learning system that is trained to encode images (e.g., trained using supervised, semi-supervised, or self-supervised learning techniques).

Encoder 314 may receive ROI information 330 and may, while encoding the image data, use different parameters (e.g., different quantization parameters (QPs)) when encoding the region(s) of interest 308 and non-region-of-interest portion(s) 310 of image(s) 306. Encoder 314 may support a quantization-parameter map having a block granularity. For example, encoder 314 may use a first QP to encode the region(s) of interest 308 and a second QP (e.g., higher than the first QP) to encode non-region-of-interest portion(s) 310 of image(s) 306. By encoding non-region-of-interest portion(s) 310 of the image data using the second (e.g., higher) QP, encoder 314 may generate encoded data that is more dense (e.g., comprised of fewer bits) than the encoded data would be if the first QP were used to encode the entirety of each of image(s) 306. For example, because the image data is encoded using higher QPs to encode non-region-of-interest portion(s) 310 of image(s) 306, the encoded data may represent image(s) 306 using fewer bits than if the entirety of each of image(s) 306 were encoded using the first QP. Identifying region(s) of interest 308, and not using higher QPs for the region(s) of interest 308 may ensure that region(s) of interest 308 retain their original image quality, thus leaving object detect, recognition, and/or tracking abilities of companion device 322 unimpaired.

Additionally, or alternatively, image-processing engine 312 or encoder 314 may apply a mask to non-region-of-interest portion(s) 310 of image(s) 306 prior to encoding the image data. Such a mask may render non-region-of-interest portion(s) 310 as a uniform value (e.g., an average intensity of image(s) 306). Masking non-region-of-interest portion(s) 310 of image(s) 306 using a uniform value may cause the resulting image data to be encoded using fewer bits per pixel, for example, because the uniform values may be coded with skip mode.

Filtering the image data, or masking the image data, may provide an additional benefit if the data is subsequently encoded using different QPs. For example, applying different QPs while encoding may introduce artifacts into images (e.g., at quantization-difference boundaries). Applying a low-pass filter or mask may limit or decrease such artifacts.

Additionally, or alternatively, pixels of region(s) of interest 308 may be padded, which may reduce artificial discontinuities and/or enhance compression gain and/or subjective quality of region(s) of interest 308 in reconstructed images. Additionally, or alternatively, non-region-of-interest portion(s) 310 may be intra coded, which may reduce dynamic random access memory traffic.

In some cases, if an object being tracked is very close to image-capture device 304, the object may occupy a large portion of image(s) 306. A tracker algorithm may be able to work with lower quality images of the object (e.g., images encoded using a relatively high QP and/or images that were filtered) because features of the object may be easily detected and/or tracked because the object occupies a large portion of image(s) 306. In such cases the large portion of image(s) 306 occupied by the object can be encoded using a higher QP and/or can be filtered to conserver bandwidth.

Additionally, or alternatively, a QP (and/or low-pass filter passband) may be determined based on an inverse relationship with a distance between an object represented by region(s) of interest 308 and image-capture device 304. The distance between the object and the image-capture device 304 may be determined by companion device 322 (e.g., based on a stereoscopic image and/or a distance sensor of companion device 322). As an example, the farther away an object is from image-capture device 304, the lower the QP selected for encoding a region(s) of interest 308 representing the object may be. As another example, the farther away an object is from image-capture device 304, the larger the passband of the low-pass filter selected for filtering a region(s) of interest 308 representing the object may be. In some cases, QPs and/or passbands may be determined by recognition and/or tracking engine 326 (e.g., such that objects in region(s) of interest 308 of reconstructed images can be detected, recognized, and/or tracked).

After encoding the image data, XR device 302 may transmit the encoded data to companion device 322 (e.g., using a communication engine which is not illustrated in FIG. 3). The encoded data may include relatively few bits (e.g., based on the low-pass filtering of the image data, encoding portions of the image data using a relatively high QP, or masking the image data). In other words, the encoded data may include fewer bits than if the entire image were encoded using a low QP, not filtered, and not masked. The encoded data, including relatively few bits, can be transmitted using less bandwidth than would be used to transmit data encoded without low-pass filtering, using a relatively high QP for portions of the image data, and/or masking. Conserving bandwidth at XR device 302 may conserve power at XR device 302.

Companion device 322 may receive the encoded data (e.g., using a communication engine which is not illustrated in FIG. 3) and provide the encoded data to decoder 324. The line between encoder 314 and decoder 324 is illustrated using a dashed line to indicate that the communication of the encoded image data between encoder 314 and decoder 324 may be wired or wireless, for example, according to any suitable communication protocol such as, USB, UWB, Wi-Fi, IEEE 902.15, or Bluetooth®. Similarly, other lines between XR device 302 and companion device 322 (including the line between ROI information 330 and image-processing engine 312, the line between ROI information 330 and encoder 314, and the line between encoder 334 and decoder 316) are illustrated using dashed lines to indicate that the communications represented by such lines may be wired or wireless.

Decoder 324 (which may be a codec) may decode the encoded image data. Decoder 324 may be, or may implemented in, a circuit or a chip (e.g., an FPGA or a processor). The decoded image data may not be the same as image(s) 306. For example, the decoded image data may be different from image(s) 306 based on image-processing engine 312 applying a low-pass filter to the image data and/or applying a mask before encoding the image data and/or based on decoder 324 applying different QPs to the image data while encoding the image data. Nevertheless, based on image-processing engine 312 filtering and/or masking non-region-of-interest portion(s) 310 and not region(s) of interest 308, and/or based on encoder 314 using a relatively low QP when encoding region(s) of interest 308, region(s) of interest 308 may be substantially the same in the decoded image data as in image(s) 306.

Recognition and/or tracking engine 326 (which may be, or may implemented in, a circuit or a chip (e.g., an FPGA or a processor)) may receive the decoded image data and perform operations related to: object detection, object recognition, object tracking, hand tracking, semantic segmentation, saliency detection, and/or other computer-vision tasks using the decoded image data. For example, recognition and/or tracking engine 326 may identify region(s) of interest 308 based on based on an object-recognition technique (e.g., identifying an object represented in image(s) 306 and tracking the position of the object through multiple image(s) 306). As another example, recognition and/or tracking engine 326 may identify region(s) of interest 308 based on a hand-tracking technique (e.g., identifying a hand as a region of interest 308 and/or identifying a region of interest 308 using a hand as an indicator, such as the hand pointing at the region of interest 308). As another example, recognition and/or tracking engine 326 may identify region(s) of interest 308 based on a semantic-segmentation technique or a saliency-detection technique (e.g., determining important regions of image(s) 306).

Recognition and/or tracking engine 326 may identify region(s) of interest 308 so that recognition and/or tracking engine 326 can track objects in region(s) of interest 308. Region(s) of interest 308 may be related to objects detected and/or tracked by recognition and/or tracking engine 326. For example, region(s) of interest 308 may be bounding boxes including the detected and/or tracked objects.

Recognition and/or tracking engine 326 may generate ROI information 330 indicative of the determined region(s) of interest 308 and provide ROI information 330 to image-processing engine 312 and/or encoder 314. Additionally, or alternatively, recognition and/or tracking engine 326 may determine object pose 328. Object pose 328 may be indicative of a position and/or orientation of objects detected and/or tracked by recognition and/or tracking engine 326.

Rendering 332 (which may be, or may implemented in, a circuit or a chip (e.g., an FPGA or a processor)) may receive object pose 328 from recognition and/or tracking engine 326 and may render images for display by XR device 302 based on object pose 328. For example, rendering 332 may determine where in a display 320 of XR device 302 to display virtual content based on object pose 328. As an example, rendering 332 may determine to display virtual content to overlay tracked real-world objects within a field of view of a user.

Rendering 332 may provide the rendered images to encoder 334. In some cases, encoder 334 and decoder 324 may be included in the same circuit or chip. In other cases, encoder 334 may be independent of decoder 324. In any case, encoder 334 may be, or may implemented in, a circuit or a chip (e.g., an FPGA or a processor). Encoder 334 may encode the image data from rendering 332 for transmission (e.g., as individual data packets for sequential transmission). In one illustrative example, encoder 334 can encode the image data based on a video coding standard, such as HEVC, VVC, or another video coding standard. In another illustrative example, encoder 334 can encode the image data using a machine-learning system that is trained to encode images (e.g., trained using supervised, semi-supervised, or self-supervised learning techniques).

After encoding the image data, companion device 322 may transmit the encoded data to XR device 302 (e.g., using a communication engine which is not illustrated in FIG. 3). XR device 302 may receive the encoded data (e.g., using a communication engine which is not illustrated in FIG. 3) and decode the encoded data at a decoder 316. In some cases, decoder 316 and encoder 314 may be included in the same circuit or chip. In other cases, decoder 316 may be independent of encoder 314. In any case, decoder 316 may be, or may implemented in, a circuit or a chip (e.g., an FPGA or a processor).

Image-processing engine 318 may receive the decoded image data from decoder 316 and process the decoded images data. For example, image-processing engine 318 may perform one or more of: color conversion, error concealment, and/or image warping for display-time head pose (which may also be referred to in the art as late stage reprojection). Display 320 may receive the processed image data from image-processing engine 318 and display the image data.

In some cases, XR device 302 may periodically transmit additional image data entirely encoded using the one QP (e.g., a relatively low QP), without low-pass filtering or masking. Such images may allow recognition and/or tracking engine 326 to detect objects and/or identify additional region(s) of interest 308 or update region(s) of interest 308. Additionally, or alternatively, in some cases, recognition and/or tracking engine 326 may request that XR device 302 capture and send one or more image(s) 306 encoded using a relatively low QP and/or without low-pass filtering. Recognition and/or tracking engine 326 may request such image(s) 306 based on determining a possibility that a new object may be represented in such image(s) 306.

As noted above, systems and techniques are described herein that can be used to provide adaptive workload balancing between an XR HMD and a companion device of the split-architecture XR system. In one illustrative example, the systems and techniques can implement adaptive balancing of XR perception workload processing between the XR HMD and the companion device of the split-architecture XR system. In some aspects, the systems and techniques can implement adaptive balancing of XR render workload processing between the XR HMD and the companion device of the split-architecture XR system. In some examples, the adaptive balancing of the XR perception workload processing and/or the XR render workload processing can be based on channel condition information, where the channel condition information corresponds to one or more wireless channels between the XR HMD and the companion device of the split-architecture XR system. For example, the systems and techniques can be used to perform adaptive split perception to dynamically balance an XR perception processing workload between an XR HMD and a companion device, based on channel condition information corresponding to a wireless channel between the XR HMD and the companion device. In another example, the systems and techniques can be used to perform channel-adaptive rendering to dynamically balance an XR rendering workload between an XR HMD and a companion device, based on channel condition information corresponding to a wireless channel between the XR HMD and the companion device. In some aspects, the systems and techniques can be used to perform adaptive split perception and channel-adaptive rendering for an XR HMD and a companion device of a split-architecture XR system.

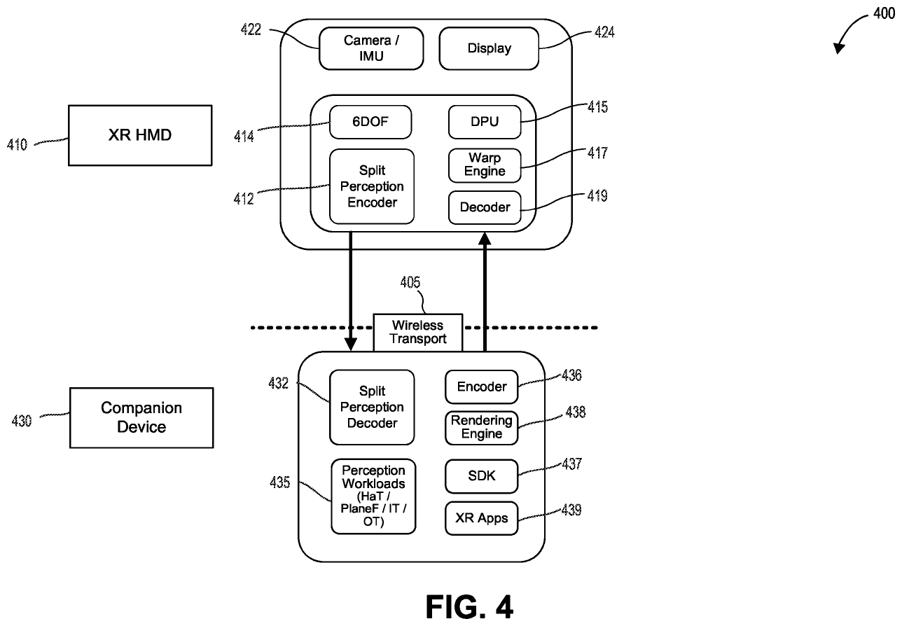

FIG. 4 is a block diagram illustrating an example of a split-architecture XR system 400 including an XR HMD 410 and a companion device 430, in accordance with some examples. As noted above, based on the relatively small form-factor that may be utilized for XR HMDs and/or other wearable XR devices, an XR HMD may be associated with thermal constraints that limit the processing power, computational resources, computational hardware, etc., that can be implemented by or within an XR HMD. There is a need to reduce the power consumption of XR HMDs, based at least in part on the thermal constraints and/or relatively small form-factor associated with XR HMDs.

One approach to reduce power in an XR HMD (e.g., such as the XR HMD 410) is to split processing between the HMD 410 and the companion device 430, for example based on utilizing the split-architecture XR system 400 (e.g., also referred to as a split XR system). In a split XR system, the processing load is divided (e.g., split) between an XR headset device and a host device. The XR headset device can be the XR HMD 410. The host device can also be referred to as a companion device, such as the companion device 430 (e.g., a companion device associated with the XR HMD, a companion device of the split XR system, etc.). In some aspects, a split XR system can use the host device (e.g., companion device 430) to handle a majority of the processing tasks and/or XR workload, with the XR HMD configured to handle a remaining portion (e.g., a minority) of the processing tasks and/or XR workload of the split XR system.

Various split XR system designs and/or architectures can be utilized, which may vary in the distribution of the XR processing workload across or between the XR HMD and the companion device. In some examples, all processing workloads may be performed by the companion device, with the XR HMD used to display the rendered images (e.g., images rendered based on the processing performed by the companion device) to the user.

In some examples, rendering (e.g., a high-power workload) is performed on the companion device 430. For example, companion device 430 can implement a rendering engine 438 configured to perform rendering and/or processing tasks associated with an XR render workload, based on data and/or processing instructions offloaded from the XR HMD 410 to the companion device 430. In some cases, rendering implemented by the companion device 430 of the split XR system 400 (e.g., rendering implemented using the rendering engine 438 of the companion device 430) may require the split XR system 400 to perform a late-stage reprojection.

For example, when the companion device 430 is used to perform the majority of the XR rendering workload, the split XR system 400 may configure the XR HMD 410 to perform late-stage reprojection of rendered image data output from the rendering engine 438 of the companion device 430. In some aspects, the XR HMD 410 can include a warp engine 417 that is configured to perform one or more warp operations and/or that is configured to perform the late-stage reprojection of the rendered image data output by the rendering engine 438 of the companion device 430. In the late-stage reprojection (LSR), the XR HMD 410 can use the warp engine 417 to reproject a previously-rendered frame for the latest head pose information of the user to reduce motion-to-photon latency and avoid user nausea.

In some aspects, processing workloads associated with head and/or pose tracking of the user (e.g., the user of the XR HMD 410 and/or the split XR system 400) may be performed on the XR HMD 410, and are not offloaded to the companion device 430 in the split perception XR system 400. For example, the XR HMD 410 can implement the head and/or pose tracking utilizing a 6DOF engine 414, which can be used to process information obtained using one or more cameras, IMUs, inertial sensors, etc., included in the XR HMD 410 (e.g., such as the camera/IMU 422, etc.).

In some examples, the XR HMD 410 can additionally include one or more cameras and/or inertial measurement units (IMUs) 422, and one or more display panels 424. For example, the XR HMD 410 may include a respective one or more displays 424 corresponding to a left eye output and a respective one or more displays 424 corresponding to a right eye output. In some aspects, the displays 424 can be associated with one or more eyebuffers (e.g., also referred to as XR eyebuffers, eye buffers, frame buffers, etc.). For example, the one or more left eye displays 424 can be associated with at least one left eyebuffer configured to store rendered images for output to the user's left eye, the one or more right eye displays 424 can be associated with at least one right eyebuffer configured to store rendered images for output to the user's right eye, etc.

In some aspects, the XR HMD 410 can include one or more digital processing units (DPUs) 415, which may be used to perform processing associated with one or more XR workloads and/or XR workload types, etc. In some examples, the XR HMD 410 may further include a split perception encoder 412, configured to perform split perception processing associated with the XR HMD 410 and the companion device 430. The split perception encoder 412 can be used to encode data corresponding to perception tasks and/or workloads that are offloaded from the XR HMD 410 to the companion device 430. For example, split perception encoder 412 can encode image data from the camera 422, inertial data from the IMU 422, etc., for transmission to the companion device 430.

In some aspects, XR processing workloads that can be offloaded from the XR HMD 410 to the companion device 430 (e.g., workloads that can be performed by the companion device 430) can include one or more perception workloads 435. For example, the perception workloads 435 can include one or more of hand tracking (HaT), plane finding (PlaneF), image tracking (IT), object tracking (OT), head tracking, body tracking, 3D reconstruction (3DR), etc., some or all of which may be implemented on the XR HMD 410, the companion device 430, and/or combinations thereof (e.g., based on latency and/or power requirements for the split XR system 400, etc.).

The companion device 430 can include a split perception decoder 432 for decoding the encoded information received from XR HMD 410 and the split perception encoder 412 thereof. For example, the split perception decoder 432 of the companion device 430 can be associated with the split perception encoder 412 of the XR HMD 410. The companion device 430 can further include one or more XR applications 437, one or more software development kits (SDKs) 437, one or more rendering engines 438, and one or more encoders 436. In some cases, the rendering engine 438 of the companion device 430 can be used to render one or more frames of image data (e.g., XR image data or content) for output to a respective eyebuffer associated with a left eye display 424 or a right eye display 424 of the XR HMD 410.

In some aspects, the encoder 436 of the companion device 430 can be used to encode rendered data generated as output by the rendering engine 438. For example, the encoder 436 can encode one or more rendered frames generated by the rendering engine 438, where the encoded rendered frames from the encoder 436 are subsequently transmitted to the XR HMD 410 and stored in a respective eyebuffer thereof. For example, in some cases, the companion device 430 can encode eyebuffers as a rendered frame or rendered information that is transmitted back to the XR HMD 410, as will be described in greater depth below.

In some examples, the split XR system 400 can be implemented using one or more wireless communication channels (e.g., wireless transport 405) between the XR HMD 410 and the companion device 430. For example, the communications between the XR HMD 410 and the companion device 430 may be implemented as WiFi communications. In some aspects, the wireless transport 405 of FIG. 4 can correspond to a 6 GHz WiFi or other wireless transport network.

In one illustrative example, the adaptive split perception implemented by the XR HMD 410 and the companion device 430 can be configured based on channel conditions of the wireless transport network 405 (e.g., based on channel conditions of the WiFi network, or channels thereof, used for communications between the XR HMD 410 and the companion device 430). For example, an XR perception workload associated with the split XR system 400 can be balanced across (e.g., between) the XR HMD 410 and the companion device 430. In one illustrative example, an XR perception workload associated with the split XR system 400 can be balanced across (e.g. between) the split perception encoder 412 of the XR HMD 410 and the split perception decoder 432 and/or perception workloads engine 435 of the companion device 430. In some aspects, the balancing of the XR perception workload between the XR HMD 410 and the companion device 430 can be based on channel condition information corresponding to one or more wireless communication channels of the wireless transport network 405 between the XR HMD 410 and the companion device 430.

In some aspects, the power associated with and/or consumed by performing wireless communications over a WiFi network (e.g., the wireless transport network 405) may be higher in relatively poor channel conditions, and may be lower in relatively clear channel conditions. For example, the XR HMD 410 and/or the companion device 430 may utilize more power to transmit information over the wireless transport network 405 in relatively poor channel conditions, relative to the lesser power the XR HMD 410 and/or the companion device 430 would utilize to transmit the same information over the wireless transport network 405 in relatively good channel conditions.

In some cases, relatively poor wireless channel conditions can decrease the performance of an XR device (e.g., XR HMD 410, etc.) that is configured to offload processing of perception workloads to a companion device (e.g., companion device 430) for power savings. For example, relatively poor wireless channel conditions on the wireless transport network 405 can increase the latency and/or bit-error rate of transmissions over the channel, and/or may decrease the bandwidth of wireless communications associated with transmitting encoded split perception information from the split perception encoder 412 of the XR HMD 410 to the split perception decoder 432 of the companion device 430 for perception workload processing by the companion device 430. In another example, relatively poor wireless channel conditions on the wireless transport network 405 may increase the latency and/or bit-error rate, and/or may decrease the bandwidth of wireless communications associated with transmitting the encoded, processed perception workload data from the encoder 436 of the companion device 430 back to the XR HMD 410 for output to the user of the XR HMD 410.

In some cases, a power consumption associated with transmitting (e.g., between the XR HMD 410 and the companion device 430) information corresponding to the offloaded perception workload in poor channel conditions is higher than a power consumption saved from offloading the perception workload. For example, WiFi communications over a channel between the XR HMD 410 and companion device 430 (e.g., wireless transport network 405) can be implemented using a modulation coding scheme (MCS) that is based at least in part on channel condition information of the channel. In clear channel conditions, a more sophisticated and/or more efficient MCS can be utilized, which consumes less power at the XR HMD 410 and the companion device 430. In poor channel conditions, a less sophisticated and less efficient MCS may be utilized, consuming significantly more power at the XR HMD 410 and the companion device 430. In some aspects, during poor channel conditions of the wireless transport network 405, the reduction in power consumption at the XR HMD 410 associated with offloading the perception processing workload to the companion device 430 can be less than the increase in power consumption at the XR HMD 410 to transmit and/or receive information corresponding to the offloaded perception processing workload to and from (respectively) the companion device 430.

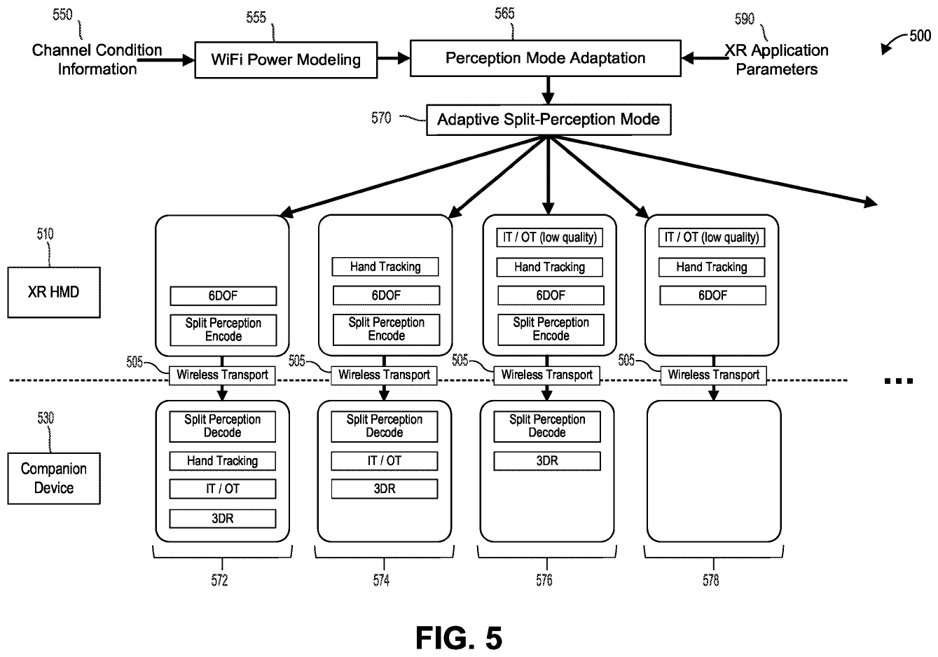

FIG. 5 is a block diagram illustrating an example of a split-architecture XR system 500 including a split perception mode adaptation engine 565 that can be used to balance (e.g., split, distribute, etc.) XR perception workload processing between an XR HMD 510 and a companion device 530 of the split XR system 500. In some aspects, the XR HMD 510 of FIG. 5 can be the same as or similar to the XR HMD 410 of FIG. 4. In some examples, the companion device 530 of FIG. 5 can be the same as or similar to the companion device 430 of FIG. 4.

In some aspects, the split-architecture XR system 500 (e.g., also referred to as the split XR system 500) can include at least the XR HMD 510 and the companion device 530. In some examples, a WiFi power modeling engine 555 and/or a perception mode adaptation engine 565 can be included in the split XR system, and may be separate from the XR HMD 510 and/or the companion device 530, or may be implemented by one or more of the XR HMD 510 and/or the companion device 530.

In one illustrative example, the WiFi power modeling engine 555 and the perception mode adaptation engine 565 can be used to determine an adaptive split perception mode 570 based on channel condition information 550 (e.g., WiFi channel condition information) and one or more XR application parameters 590. The adaptive split perception mode 570 can be selected or determined as a particular split perception mode out of a plurality of configured split perception modes 572, 574, 576, 578, . . . , etc., that are configured and/or associated with the split XR system 500.

In one illustrative example, the WiFi power modeling engine 555 and the perception mode adaptation engine 565 can be implemented on the XR HMD 510, to determine the adaptive split perception mode 570 locally at the XR HMD 510. The XR HMD 510 can signal or indicate to companion device 530 information indicative of the selected adaptive split perception mode 570 that is to be used, and the XR HMD 510 and the companion device 530 can implement their respective split perception configuration as indicated by the selected split perception mode 570 (e.g., the selected one of the plurality of split perception modes 572, 574, 576, 578, . . . , etc.).

In another illustrative example, the WiFi power modeling engine 555 and the perception mode adaptation engine 565 can be implemented on the companion device 530, to determine the adaptive split perception mode 570 locally at the companion device 530. The companion device 530 can signal or indicate to XR HMD 510 information indicative of the selected adaptive split perception mode 570 that is to be used, and the XR HMD 510 and the companion device 530 can implement their respective split perception configuration as indicated by the selected split perception mode 570 (e.g., the selected one of the plurality of split perception modes 572, 574, 576, 578, . . . , etc.).

The WiFi power modeling engine 555 can perform WiFi power modeling based on channel condition information 550 (e.g., information corresponding to WiFi channel conditions of a WiFi channel between the XR HMD 510 and the companion device 530). For example, WiFi power modeling engine 555 can be implemented as a parameter-based model that receives as input various parameters of the WiFi channel conditions. In some aspects, the channel condition information 550 can correspond to one or more wireless channels (e.g., WiFi channels) between the XR HMD 510 and companion device 530, where the one or more wireless channels are used to communicate information of the offloaded perception workload from the XR HMD 510 to the companion device 530 for split processing, and are subsequently used to communicate the processed perception workload information from the companion device 530 back to the XR HMD 510. For example, the channel condition information 550 can correspond to the wireless transport network or channel 505 between the XR HMD 510 and the companion device 530. In some aspects, the wireless transport 505 of FIG. 5 can be the same as or similar to the wireless transport 405 of FIG. 4.

As noted above, the channel condition information 550 can include information indicative of a current or most recent previous channel conditions measured or determined on the wireless transport network 505 between the XR HMD 510 and companion device 530. In some cases, the channel condition information 550 can include one or more channel condition parameters that can be provided as input to the WiFi power modeling engine 555 for subsequent WiFi power modeling. The parameters whose values are provided as input to WiFi power modeling engine 555 can include one or more of a current MCS used on the WiFi channel (e.g., of wireless transport network 505), a modem bitrate (e.g., at one or more, or both, of the XR HMD 510 and/or companion device 530), a signal strength (e.g., one or more Received Signal Strength Indicator (RSSI) measurements, a signal-to-noise ratio (SNR), a signal-to-interference-to-noise ratio (SINR), a channel bandwidth, interference measurements, latency measurements, data rate or throughput measurements, etc.

Based on the parameter values and/or other WiFi channel condition information indicated by the channel condition information 550, the WiFi power modeling engine 555 can generate an estimated (e.g., modeled or predicted) power associated with transmitting a particular message, communication, or signal over the WiFi channel from the XR HMD 510 to the companion device 530. For example, the WiFi power modeling engine 555 can use the channel condition information 550 to dynamically estimate or determine a transmission power for an upcoming or scheduled transmission from the XR HMD 510 to the companion device 530, and/or from the companion device 530 to the XR HMD 510. In some cases, the WiFi power modeling engine 555 can use a configured or reference message to perform the transmission power estimation given the current channel condition information 550.

The perception mode adaptation engine 565 can receive the estimated transmission power value or information from the WiFi power modeling engine 555 and may be configured to compare the estimated power to transmit (e.g., offload the XR perception workload processing from the XR HMD 510 to the companion device 530) to pre-determined information indicative of the local power consumption associated with processing the same XR perception workload (or portions thereof) locally by the XR HMD 510. In some cases, the local power consumption for processing the XR perception workload locally by the XR HMD 510 can be determined based on the one or more XR application parameters 590. The XR application parameters 590 can correspond to an XR application running on the XR HMD 510 and associated with the split perception being performed with the companion device 530. For example, the XR application parameters 590 can include one or more of latency requirements, on-screen content, current tracking state, etc., associated with the XR application running on XR HMD 510.

Based on the comparison of the transmission power associated with offloading the perception workload processing from the XR HMD 510 to the companion device 530, against the local power consumption associated with not offloading the perception workload (e.g., the local power consumption associated with processing the perception workload locally by the XR HMD 510), the perception mode adaptation engine 565 can determine an adaptive split perception mode 570 to be used by the XR HMD 510 and companion device 530. The adaptive split perception mode 570 can be selected from a plurality of adaptive split perception modes 572, 574, 576, 578, . . . , etc. In some cases, the perception mode adaptation engine 565 can select between adaptive split perception modes 570 that correspond to a higher-quality algorithm running on the companion device 530 and a lower-quality algorithm running on the XR HMD 510. For example, the perception mode adaptation engine 565 can select between the split perception configurations 576 or 578 (e.g., where relatively low-quality image tracking/object tracking (IT/OT) processing is performed locally by the XR HMD 510 and is not offloaded to the companion device 530), and the split perception configurations 572 or 574 (e.g., where relatively high-quality IT/OT processing is offloaded from the XR HMD 510 to instead be performed by the companion device 530).

In some aspects, the plurality of split perception modes 570 can correspond to different splits, balancing configurations, and/or distributions, etc., across or between the XR HMD 510 and the companion device 530 of one or more (or all) of the perception workloads 435 of FIG. 4. For example, the split perception modes 570 can correspond to different splits or distributions of a hand tracking (HaT) XR perception workload 435, an image tracking/object tracking (IT/OT) XR perception workload 435, etc.

In some examples, the XR application parameters 590 (e.g., such as latency) may require that the high-quality versions of these algorithms be re-enabled periodically. In some aspects, the plurality of adaptive split perception modes 570 can include one or more particular adaptive split perception mode configurations in which none of the XR perception workload tasks are run or processed on the companion device 530 (e.g., no XR perception workload tasks are offloaded from the XR HMD 510 to the companion device 530) and all encode/WiFi transmit and receive power can be saved at the XR HMD 510.

For example, the adaptive split perception mode configuration 572 corresponds to performing split perception workload processing where 6DOF and split perception encode processing tasks or workloads are performed by the XR HMD 510, and split perception decode, hand tracking, IT/OT, and 3DR processing tasks or workloads are performed by the companion device 530. In some cases, the adaptive split perception mode configuration 572 can correspond to good or clear channel conditions (e.g., as indicated by the parameters and/or other information indicated by the channel condition information 550), allowing the XR HMD 510 to offload the greatest quantity or percentage of perception workload to companion device 530 (e.g., based on the relatively low power requirement to transmit the corresponding data for the perception workload over the good or clear WiFi channel conditions on the wireless transport network 505).

The adaptive split perception mode configuration 574 corresponds to performing split perception where hand tracking processing is performed locally at the XR HMD 510 (e.g., is not offloaded to companion device 530, such as in configuration 572). The configuration 574 can correspond to relatively worse (e.g., poorer, lower, etc.) channel conditions 550 of the wireless transport network 505 than those associated with the configuration 572.

The adaptive split perception mode configuration 576 corresponds to performing split perception where IT/OT processing is additionally performed at the XR HMD 510 (e.g., is not offloaded to companion device 530, such as in configurations 572 and 574). The configuration 574 can correspond to relatively worse (e.g., poorer, lower, etc.) channel conditions 550 than those associated with the configurations 572 and 574. In some aspects, the IT/OT processing implemented by XR HMD 510 in configuration 576 can be a lower quality version than the relatively high quality IT/OT processing that may be implemented by companion device 530 in configurations 572 and 574.

The adaptive split perception mode configuration 578 corresponds to no split perception being performed (e.g., all perception processing tasks and workloads are performed by the XR HMD 510, and no perception processing tasks or workloads are offloaded to or processed by the companion device 530). Based on no split perception being implemented by configuration 578, the XR HMD 510 does not perform split perception encoding in configuration 578 (e.g., does not perform the split perception encoding included in the respective XR HMD 510 portion of the configurations 572, 574, 576) and the companion device 530 does not perform split perception decoding (e.g., does not perform the split perception decoding included in the respective companion device 530 portion of the configurations 572, 574, 576).

In some examples, the configuration 578 may correspond to poor or choppy channel conditions 550 that would require a very high transmit power between the XR HMD 510 and the companion device 530 to implement split perception workload processing (e.g., high transmit power of encoded split perception information transmitted from the XR HMD 510 to the companion device 530 for split or offloaded processing, and/or high transmit power of processed split perception information processed by the companion device 530 and transmitted back to the XR HMD 510, etc.). In some aspects, when no split perception tasks or workloads are offloaded to companion device 530, companion device 530 does not implement split perception decoding.

In some examples, based on the XR application parameters 590, XR HMD 510 and/or companion device 530 may opportunistically shut off perception algorithms for a period of time (e.g. 3DR in the example of configuration 578). In some examples, based on information included in and/or indicated by the XR application parameters 590 (e.g., such as latency, on-screen content, etc.), the perception mode adaptation engine 565 may periodically select a different one of the plurality of adaptive split perception mode configurations 570 to re-enable one or more perception algorithms that were previously shut off or disabled at the XR HMD 510 and/or the companion device 530 (e.g., the XR application parameters 590 may require these algorithms to be re-enabled periodically at a respective one of the XR HMD 510 and/or the companion device 530).

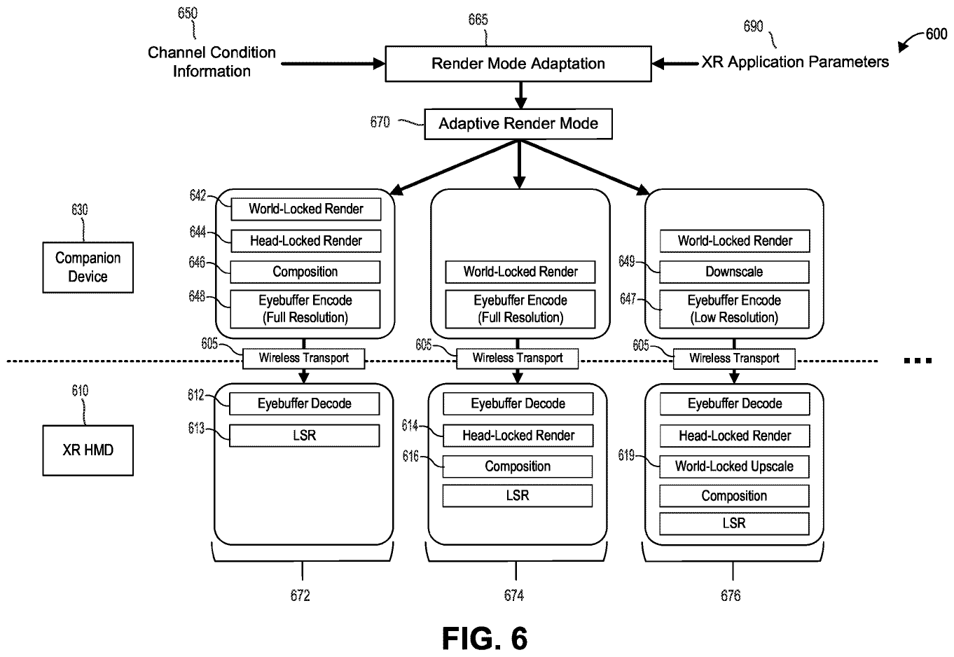

FIG. 6 is a block diagram illustrating an example of a split-architecture XR system 600 including a render mode adaptation engine 665 that can be used to balance XR render workload processing between an XR HMD 610 and a companion device 630, in accordance with some examples. In some cases, the split XR system 600 of FIG. 6 can be the same as or similar to the split XR system 500 of FIG. 5 and/or the split XR system 400 of FIG. 4. In some aspects, the XR HMD 610 of FIG. 6 can be the same as or similar to the XR HMD 510 of FIG. 5 and/or the XR HMD 410 of FIG. 4. In some examples, the companion device 630 of FIG. 6 can be the same as or similar to the companion device 530 of FIG. 5 and/or the companion device 430 of FIG. 4. In some examples, the channel condition information 650 of FIG. 6 (e.g., WiFi channel condition information) can be the same as or similar to the channel condition information 550 of FIG. 5. The XR application parameters 690 can be the same as or similar to the XR application parameters 590 of FIG. 5, and for example may include and/or may be indicative of latency requirements, on-screen content, a current tracking state, etc., of an XR application running on the XR HMD 610.

A render mode adaptation engine 665 can be used to determine an adaptive render mode 670 based on the channel condition information 650 and the one or more XR application parameters 690. For example, the adaptive render mode 670 can be a particular (e.g., selected) adaptive render mode configuration selected from a plurality of adaptive render mode configurations 672, 674, 676, . . . , etc., that are associated with and/or pre-configured for one or more of the XR HMD 610 and/or the companion device 630 of the split XR system 600.

In some examples, the render mode adaptation engine 665 can be implemented by the XR HMD 610, which can locally determine the adaptive render mode 670 to be used and can subsequently communicate the selected adaptive render mode 670 information to companion device 630. For example, the determined adaptive render mode 670 configuration can be communicated from the render mode adaptation engine 665 to one or more of the XR HMD 610 and/or the XR HMD 610 using the wireless transport network 605 (e.g., a WiFi network including one or more WiFi channels, etc.). Based on the selected adaptive render mode 670, the XR HMD 610 and the companion device 630 can implement their respective split rendering configuration as indicated by the selected adaptive render mode 670 (e.g., the selected one of the plurality of adaptive split render mode configurations 672, 674, 676, . . . , etc.). In some aspects, the render mode adaptation engine 665 can be implemented by the companion device 630, which can determine the adaptive render mode 670 to be used and communicate the selected adaptive render mode information to XR HMD 610. Based on the selected adaptive render mode 670, the XR HMD 610 and the companion device 630 can implement their respective split rendering configuration as indicated by the selected adaptive render mode 670 (e.g., the selected one of the plurality of adaptive split render mode configurations 672, 674, 676, . . . , etc.).

The render mode adaptation engine 665 can determine the adaptive render mode 670 as a particular adaptive render mode selected from a plurality of adaptive render modes (e.g., the different adaptive render mode configurations 672, 674, 676, . . . ) . For example, a first adaptive render mode configuration 672 can correspond to a determination (e.g., by the render mode adaptation engine 665) that the channel condition information 650 (e.g., WiFi channel conditions) are indicative of relatively good or clear channel conditions on the wireless transport network 605 between the XR HMD 610 and the companion device 630.

In the first adaptive split render mode configuration 672, world-locked layers and head-locked layers of the XR content and/or XR environment being presented to a user of the XR HMD 610 can be rendered and composited on the companion device 630, based on the XR HMD 610 being configured to offload the rendering and compositing processing tasks or workload to the companion device 630. For example, information or data to be processed during the rendering and compositing workload can be transmitted from the XR HMD 610 to the companion device 630, using the wireless transport network 605. Subsequently, the companion device 630 can process the received information or data to be processed, and can perform the rendering and compositing workload processing for the world-locked layers and head-locked layers (e.g., based on implementing the world-locked render 642 by the companion device 630, and implementing the head-locked render 644 by the companion device 630, respectively).

The rendered information from the world-locked render 642 and the head-locked render 644 can be provided, at the companion device 630, to a composition engine 646 that is also implemented by the companion device 630 in the first adaptive render mode configuration 672. The composition engine 646 can perform compositing of or for the world-locked render 642 and the head-locked render 646, and may generate as output one or more corresponding composited layers (e.g., eyebuffers). The composited layers corresponding to the world-locked render 642 and head-locked render 644 (e.g., eyebuffers) can be provided to an eyebuffer encoder 648 implemented by the companion device 630. The eyebuffer encoder 648 can be used to generate encoded eyebuffer information, which can be transmitted to the XR HMD 610 using the wireless transport network 605. The companion device 630 can include the eyebuffer encoder 648, where the eyebuffer encoder 648 is configured to generate encoded eyebuffers at full resolution to encode the composited layers (e.g., eyebuffers) for transmission to the XR HMD 610.

The XR HMD 610 can include a corresponding eyebuffer decoder 612 to decode the rendered and composited layers (e.g., eyebuffers) received from the companion device 630. The rendered and composited layers (e.g., eyebuffers) decoded by the eyebuffer decoder 612 can represent the processed output of the offloaded rendering and compositing tasks that are offloaded from the XR HMD 610 to the companion device 630 in the first adaptive render mode configuration 672. In some aspects, the rendered and composited layers (e.g., eyebuffers) can then be reprojected by the XR HMD 610, for example based on current head pose information of the user of the XR HMD 610, and displayed (e.g., output) to the user on one or more displays of the XR HMD 610 (e.g., such as the display(s) 424 of the XR HMD 410 of FIG. 4, which may be the same as or similar to the XR HMD 610 of FIG. 6). In some cases, the reprojection performed by the XR HMD 610 based on the decoded eyebuffer information from the eyebuffer decoder 612 can be implemented as a late-stage reprojection (LSR) and/or warping. For example, the XR HMD 610 can include and/or utilize an LSR engine 612 to perform the late-stage reprojection and/or warping of the decoded eyebuffer information from the eyebuffer decoder 612.

A second adaptive render mode configuration 674 can correspond to a determination that the channel condition information 650 (e.g., WiFi channel conditions) associated with one or more channels of the wireless transport network 605 between the XR HMD 610 and the companion device 630 is indicative of moderate channel conditions. In some aspects, the determination and/or identification of moderate channel conditions can be based on using the render mode adaptation engine 665 to analyze the channel condition information 650.

In the second adaptive split render mode configuration 674, the one or more head-locked layers are not offloaded to the companion device 630, and remain at the XR HMD 610 for local processing and implementation of the head-locked rendering workload rendering. For example, the XR HMD 610 can perform local processing (e.g., local rendering) for the head-locked render 614, based on the second adaptive split rendering configuration 674. The one or more world-locked layers can continue to be offloaded to companion device 630, as described above with respect to first configuration 672. For example, in the second adaptive split rendering configuration 674, the XR HMD 610 implements local processing of the head-locked render 614, and offloads processing of the world-locked render 642 to the companion device 630 as described above with respect to the first adaptive split render configuration 672.

In some aspects, the XR HMD 610 does not offload composition (e.g., compositing workload processing of the rendered head-locked and world-locked layers) to the companion device 630 in the second adaptive split render configuration 674. For example, the XR HMD 610 can perform local processing (e.g., local composition) of the world-locked render 642 received over wireless transport network 605 from the companion device 630 and the head-locked render 614 generated locally at the XR HMD 610. For example, the XR HMD 610 can use the local composition engine 616 to perform compositing of the offloaded world-locked render 642 and the local head-locked render 614. The local composition engine 616 implemented by the XR HMD 610 can be the same as or similar to the composition engine 646 implemented by the companion device 630 in the first adaptive split render configuration 672. The XR HMD 610 can received rendered world-locked layers 642 from the companion device 630 (e.g., encoded by the eyebuffer encoder 648 at full resolution by the companion device 630) and may decode the received world-locked layers 642 with the eyebuffer decoder 612 implemented by the XR HMD 610. The XR HMD 610 can subsequently use the local composition engine 616 to perform compositing of the locally-rendered head-locked layers 614 processed by XR HMD 610 with the decoded rendered world-locked layers 642 received from the companion device 630. In the second adaptive split render configuration 674, the XR HMD 610 can include and use the LSR engine 613 to perform late-stage reprojection and/or warping of the composited world-locked rendered layers and head-locked rendered layers for output to a display of the XR HMD 610.

A third adaptive split render mode configuration 676 can correspond to a determination (e.g., by the render mode adaptation engine 665) that the channel condition information 650 (e.g., WiFi channel conditions) associated with the one or more channels of the wireless transport network 605 between the XR HMD 610 and the companion device 630 is indicative of poor channel conditions. In the third adaptive split render mode configuration 676, the one or more head-locked layers can be rendered locally by the XR HMD 610, as described above with respect to the second adaptive split render configuration 674 (e.g., using the head-locked render 614 implemented locally by the XR HMD 610). The one or more world-locked layers can be offloaded for rendering by the companion device 630 (e.g., the offloaded world-locked render 642 implemented by the companion device 630), as described above with respect to second adaptive split render configuration 674.

In the third adaptive split render mode configuration 674, the world-locked renders 642 generated by companion device 630 can be downscaled (e.g., by the companion device 630) by a downscaling engine 649 included in companion device 630. The downscaling engine 649 can receive as input the full resolution world-locked render 642 information generated by the companion device 630, and can generate as output a downscaled (e.g., lower resolution) world-locked render information for transmission to the XR HMD 610 over the wireless transport network 605. The downscaled world-locked renders generated by the downscaling engine 649 of the companion device 630 can be encoded by a low-resolution eyebuffer encoder 647 implemented by companion device 630, and transmitted to XR HMD 610. For example, the low-resolution eyebuffer encoder 647 can correspond to the lower resolution of the downscaled world-locked renders generated by the downscaling engine 649. The low-resolution eyebuffer encoder 647 can be the same as or similar to the full-resolution eyebuffer encoder 648 of the first adaptive split render configuration 672 and the second adaptive split render configuration 674 (e.g., which correspond to the full resolution of the non-downscaled world-locked renders generated by the offloaded world-locked render 642 of the companion device 630).

The encoded, downscaled eyebuffer information corresponding to the offloaded world-locked render 642 generated by the companion device 630 can be transmitted from the eyebuffer encoder 647 of the companion device 630 to the eyebuffer decoder 612 of the XR HMD 610, using the wireless transport network 605. In some aspects, the XR HMD 610 can use the eyebuffer decoder 612 to decode the downscaled world-locked renders received from companion device 630. The output of the eyebuffer decoder 612 in the third adaptive split render configuration 676 can be the low-resolution (e.g., downscaled) world-locked renders generated by the companion device 630.

In one illustrative example, the third adaptive split render configuration 676 can configure the XR HMD 610 with a world-locked upscaling engine 619, configured to upscale the low-resolution (e.g., downscaled) world-locked renders received and decoded from the companion device 630. For example, the world-locked upscaling engine 619 can reverse the downscaling operations performed by the downscaling engine 649 of the companion device 630 (e.g., the world-locked upscaling engine 619 can recover the original, full-resolution of the world-locked render 642 at the companion device 630 prior to the downscaling 649 at the companion device 630). For example, the decoded downscaled world-locked renders from companion device 630 can be processed using a world-locked super resolution engine (e.g., the world-locked upscaling engine 619) included in XR HMD 610. The output of the world-locked upscaling engine 619 implemented by the XR HMD 610 in the third adaptive split ren der configuration 676 can be the world-locked layers rendered by the companion device 630, recovered to their original resolution. The upscaled world-locked layers and the locally-rendered head-locked layers generated by the XR HMD 610 can then be composited and reprojected by XR HMD 610, using the composition engine 616 and LSR engine 613, respectively, which may be implemented by the XR HMD 610 in the third adaptive split render configuration 676 to be the same as or similar to the respective implementations of the composition engine 616 and/or the LSR engine 613 by the XR HMD 610 in the first adaptive split render configuration 672 and/or the second adaptive split render configuration 674

In some aspects, the render and/or composition rate of the XR HMD 610 may be higher than the render rate of the companion device 630 when in poor channel conditions (e.g., such as those associated with the third adaptive split render configuration 676) of the one or more wireless channels of the wireless transport network 605 between the XR HMD 610 and the companion device 630, and as indicated by the channel condition information 650, allowing head-locked layers (e.g., most noticeable to user) to be updated at higher rate, even if world-locked layers cannot be sent due to poor channel conditions.

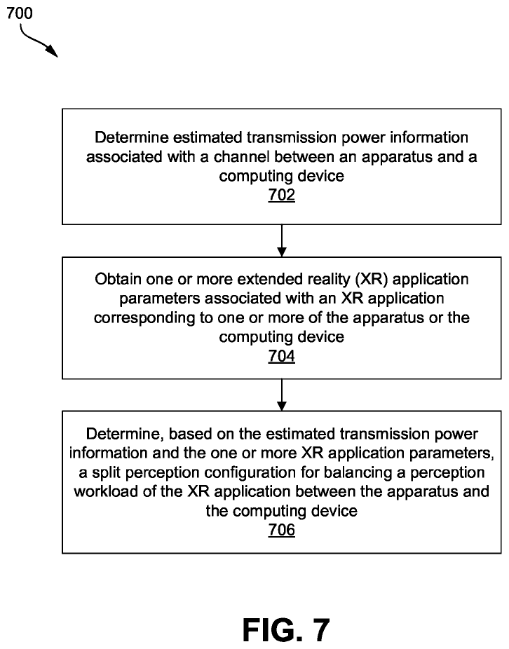

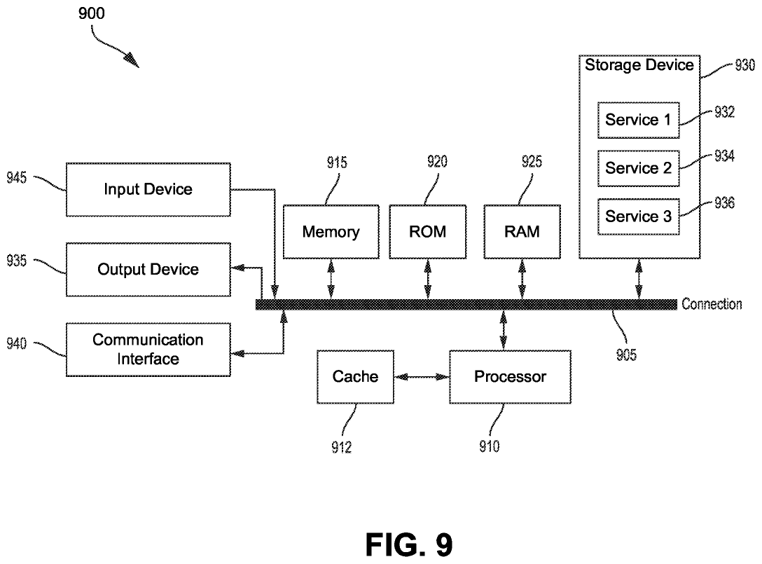

FIG. 7 is a flowchart diagram illustrating an example of a process 700 for processing image data, in accordance with aspects of the present disclosure. One or more operations of process 700 may be performed by a computing device (or apparatus), or a component or system (e.g., one or more chipsets, one or more codecs, one or more processors such as one or more CPUs, DSPs, NPUs, NSPs, microcontrollers, ASICs, FPGAS, programmable logic devices, discrete gates or transistor logic components, discrete hardware components, etc., any combination thereof, and/or other component or system) of the computing device or apparatus. The operations of the process 700 may be implemented as software components that are executed and run on one or more processors (e.g., processor 910 of FIG. 9 or other processor(s)). In some examples, the process 700 can be performed by a computing device comprising a smartphone, mobile computing device, user computer device, etc. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device.

At block 702, the computing device (or component thereof) can determine estimated transmission power information associated with a channel between an apparatus and a computing device. In some examples, the apparatus comprises an extended reality (XR) device and the computing device comprises a companion device. In some examples, the apparatus comprises the companion device and the computing device comprises the XR device.

In some examples, the XR device may be the same as or similar to one or more of the XR device 102 of FIG. 1A, the HMD 120 of FIGS. 1B and 1C, the XR system 200 of FIG. 2, the XR device 302 of FIG. 3, the XR HMD 410 of FIG. 4, the XR HMD 510 of FIG. 5, and/or the XR HMD 610 of FIG. 6. In some examples, the companion device may be the same as or similar to one or more of the companion device 104 of FIG. 4, the companion device 322 of FIG. 3, the companion device 430 of FIG. 4, the companion device 530 of FIG. 5, and/or the companion device 630 of FIG. 6.

In some cases, the estimated transmission power information is indicative of an estimated power associated with transmitting encoded image data from an XR device to a companion device. For example, the encoded image data can be associated with a split perception encoder 412 included in an XR device such as the XR HMD 410 of FIG. 4 and/or can be associated with a split perception decoder such as the split perception decoder 432 of the companion device 430 of FIG. 4.

In some cases, the estimated transmission power information is further indicative of an estimated power associated with encoding image data by the XR device. For example, the estimated transmission power information can be further indicative of an estimated power associated with encoding image data using a split perception encoder, such as the split perception encoder 412 of FIG. 4 and/or the split perception encoder of FIG. 5.

In some cases, the estimated transmission power information is based on channel condition information corresponding to the channel between the apparatus and the computing device. For example, the channel condition information can be the same as or similar to the channel condition information 550 of FIG. 5. In some examples, the channel condition information comprises WiFi channel condition information. In some cases, the channel condition information is indicative of a modulation coding scheme (MCS) associated with transmissions on the channel.

In some cases, the estimated transmission power information can be determined based on performing WiFi power modeling based on the WiFi channel condition information. For example, the estimated transmission power information can be determined based on performing WiFi power modeling using the WiFi Power Modeling engine 555 of FIG. 5 and the channel condition information 550 (e.g., WiFi channel condition information) of FIG. 5.

At block 704, the computing device (or component thereof) can obtain one or more extended reality (XR) application parameters associated with an XR application corresponding to one or more of the apparatus or the computing device. For example, the one or more XR application parameters may be the same as or similar to one or more of the XR application parameters 590 of FIG. 5. In some cases, the one or more XR application parameters can include one or more of latency requirements, on-screen content, current tracking state, etc.

At block 706, the computing device (or component thereof) can determine, based on the estimated transmission power information and the one or more XR application parameters, a split perception configuration for balancing a perception workload of the XR application between the apparatus and the computing device. For example, the split perception configuration can be the same as or similar to one or more of the split perception configurations 572, 574, 576, and/or 578 depicted in FIG. 5.

In some examples, where the estimated transmission power information is indicative of an estimated power associated with transmitting encoded image data from an XR device to a companion device, the split perception configuration can be determined based on comparing the estimated power to a second estimated power associated with processing the perception workload by the XR device. For example, the second estimated power associated with processing the perception workload by the XR device can be based on the one or more XR application parameters.

In some examples, the split perception configuration can be determined using a perception mode adaptation engine that is the same as or similar to the perception mode adaptation engine 550 of FIG. 5.

In some cases, the split perception configuration is selected from a plurality of split perception configurations (e.g., such as the split perception configurations 572, 574, 576, and 578 of FIG. 5). In some examples, each respective split perception configuration of the plurality of split perception configurations is indicative of a respective subset of perception workload tasks performed by the apparatus and a respective subset of perception workload tasks performed by the computing device.

In some examples, the split perception configuration is indicative of a selection between the apparatus and the computing device for performing one or more perception workload tasks, the one or more perception workload tasks including one or more of hand tracking, head tracking, plane finding, image tracking, body tracking, or three-dimensional reconstruction.

In some examples the plurality of split perception configurations includes at least a first split perception configuration associated with clear channel conditions between the apparatus and the computing device and a second split perception configuration associated with poor channel conditions between the apparatus and the computing device.

In some cases, a quantity of perception workload tasks offloaded from the apparatus to the computing device is greater in the first split perception configuration than in the second split perception configuration, and a quantity of perception workload tasks performed by the apparatus is smaller in the first split perception configuration than in the second split perception configuration. In some cases, the plurality of split perception configurations includes at least one split perception configuration corresponding to no perception workload tasks being offloaded from the apparatus to the computing device (e.g., such as the split perception configuration 578 of FIG. 5).

FIG. 8 is a flowchart diagram illustrating an example of a process 800 for processing image data, in accordance with aspects of the present disclosure. One or more operations of process 800 may be performed by a computing device (or apparatus), or a component or system (e.g., one or more chipsets, one or more codecs, one or more processors such as one or more CPUs, DSPs, NPUs, NSPs, microcontrollers, ASICs, FPGAS, programmable logic devices, discrete gates or transistor logic components, discrete hardware components, etc., any combination thereof, and/or other component or system) of the computing device or apparatus. The operations of the process 800 may be implemented as software components that are executed and run on one or more processors (e.g., processor 910 of FIG. 9 or other processor(s)). In some examples, the process 800 can be performed by a computing device comprising a smartphone, mobile computing device, user computer device, etc. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device.

At block 802, the computing device (or component thereof) can determine channel condition information associated with a channel between an apparatus and a computing device. In some examples, the apparatus comprises an extended reality (XR) device and the computing device comprises a companion device. In some examples, the apparatus comprises the companion device and the computing device comprises the XR device.

In some examples, the XR device may be the same as or similar to one or more of the XR device 102 of FIG. 1A, the HMD 120 of FIGS. 1B and 1C, the XR system 200 of FIG. 2, the XR device 302 of FIG. 3, the XR HMD 410 of FIG. 4, the XR HMD 510 of FIG. 5, and/or the XR HMD 610 of FIG. 6. In some examples, the companion device may be the same as or similar to one or more of the companion device 104 of FIG. 4, the companion device 322 of FIG. 3, the companion device 430 of FIG. 4, the companion device 530 of FIG. 5, and/or the companion device 630 of FIG. 6.

In some cases, the channel condition information comprises WiFi channel condition information. For example, the channel condition information can be the same as or similar to the channel condition information 650 of FIG. 6. In some examples, the channel condition information is indicative of a modulation coding scheme (MCS) associated with transmissions on the channel.

At block 804, the computing device (or component thereof) can obtain one or more extended reality (XR) application parameters associated with an XR application corresponding to one or more of the apparatus or the computing device. For example, the one or more XR application parameters may be the same as or similar to one or more of the XR application parameters 590 of FIG. 5. In some cases, the one or more XR application parameters can include one or more of latency requirements, on-screen content, current tracking state, etc.

At block 806, the computing device (or component thereof) can determine, based on the channel condition information and the one or more XR application parameters, a render mode configuration for balancing a render workload of the XR application between the apparatus and the computing device. In some examples, the render mode configuration is selected from a plurality of render mode configurations, each respective render mode configuration of the plurality of render mode configurations corresponding to a respective channel condition state. For example, the render mode configuration can be the same as or similar to one or more of the render mode configurations 672, 674, and/or 676 of FIG. 6. The render mode configurations 672-676 can correspond to a respective channel condition state associated with channel condition information 650 and/or can correspond to render mode adaptation information determined using a render mode adaptation engine 665, both depicted in FIG. 6.

In some cases, the plurality of render mode configurations includes a first render mode configuration associated with a clear channel condition state indicated by channel condition information. For example, the first render mode configuration can be the same as or similar to the render mode configuration 672 of FIG. 6. In some examples, the plurality of render mode configurations includes a second render mode configuration associated with a moderate channel condition state indicated by channel condition information. For example, the second render mode configuration can be the same as or similar to the render mode configuration 674 of FIG. 6.

In some examples, in the first render mode configuration the apparatus can transmit, to the computing device, encoded image data obtained from one or more cameras of the apparatus. The apparatus can receive, from the computing device, a rendered eyebuffer associated with one or more world-locked layers and one or more rendered head-locked layers, the rendered eyebuffer based on the encoded image data. For example, the rendered eyebuffer can be associated with the world-locked render and the head-locked render associated with the companion device 630 in render mode configuration 672 of FIG. 6. The rendered eyebuffer can be generated using the composition associated with the companion device 630 in render mode configuration 672 of FIG. 6. In some examples, the apparatus can perform reprojection of the rendered eyebuffer. For example, reprojection can be performed using the LSR of XR HMD 610 associated with render mode configuration 672 of FIG. 6. For example, the reprojection can be a late-stage reprojection (LSR) or warping of the rendered eyebuffer based on head pose information determined by the apparatus.

In another example, in the second render mode configuration, the apparatus can transmit, to the computing device, encoded image data obtained from one or more cameras of the apparatus. The apparatus can render one or more head-locked layers based on the image data, for example using the head-locked render associated with the XR HMD 610 in render mode configuration 674 of FIG. 6. The apparatus can receive, from the computing device, a rendered eyebuffer associated with one or more world-locked layers (e.g., for example, a rendered eyebuffer associated with the world-locked render of the companion device 630 in render mode configuration 674 of FIG. 6). The apparatus can combine the one or more head-locked layers with the rendered eyebuffer, for example using the composition and/or LSR of XR HMD 610 in render mode configuration 674 of FIG. 6.

In some cases, the plurality of render mode configurations further includes a third render mode configuration associated with a poor channel condition state indicated by channel condition information. For example, the third render mode configuration can be the same as or similar to the render mode configuration 676 of FIG. 6. In some cases, in the third render mode configuration, the apparatus can transmit, to the computing device, encoded image data obtained from one or more cameras of the apparatus. The apparatus can render one or more head-locked layers based on the image data, for example using the head-locked render of XR HMD 610 in render mode configuration 676 of FIG. 6. The apparatus can receive, from the computing device, a downscaled rendered eyebuffer associated with one or more downscaled world-locked layers. For example, the downscaled rendered eyebuffer can be associated with the low resolution eyebuffer encode of companion device 630 in render mode configuration 676 of FIG. 6. The apparatus can upscale the one or more downscaled world-locked layers, for example using the world-locked superRes of the XR HMD 610 in render mode configuration 676 of FIG. 6. The apparatus can combine the one or more head-locked layers with the one or more upscaled world-locked layers, for example using the composition and/or LSR of the XR HMD 610 in render mode configuration 676 of FIG. 6.

In some examples, the processes described herein (e.g., process 700, process 800, and/or other processes described herein) can be performed, in whole or in part, by a computing device or apparatus. In one example, one or more of the methods can be performed by XR system 100 of FIG. 1A, XR device 102 of FIG. 1A, companion device 104 of FIG. 1A, HMD 120 of FIGS. 1B and 1C, XR system 200 of FIG. 2, XR system 300 of FIG. 3, XR device 302 of FIG. 3, companion device 322 of FIG. 3, XR HMD 410 of FIG. 4, companion device 430 of FIG. 4, XR HMD 510 of FIG. 5, companion device 530 of FIG. 5, XR HMD 610 of FIG. 6, companion device 630 of FIG. 6, or another system or device. In another example, one or more of the methods can be performed, in whole or in part, by the computing-device architecture 900 shown in FIG. 9. For example, a computing device with the computing-device architecture 900 shown in FIG. 9 can include, or be included in, the components of the XR system 100 of FIG. 1A, XR device 102 of FIG. 1A, companion device 104 of FIG. 1A, HMD 120 of FIGS. 1B and 1C, XR system 200 of FIG. 2, XR system 300 of FIG. 3, XR device 302 of FIG. 3, companion device 322 of FIG. 3, XR HMD 410 of FIG. 4, companion device 430 of FIG. 4, XR HMD 510 of FIG. 5, companion device 530 of FIG. 5, XR HMD 610 of FIG. 6, companion device 630 of FIG. 6, or another system or device and can implement the operations of the process 700 and/or other processes described herein.

The computing device can include any suitable device, such as a vehicle or a computing device of a vehicle, a mobile device (e.g., a mobile phone), a desktop computing device, a tablet computing device, a wearable device (e.g., a VR headset, an AR headset, AR glasses, a network-connected watch or smartwatch, or other wearable device), a server computer, a robotic device, a television, and/or any other computing device with the resource capabilities to perform the processes described herein, including process 700, process 800, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 700, process 800, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 700, process 800, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 9 illustrates an example computing-device architecture 900 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 900 may include, implement, or be included in, any or all of XR system 100 of FIG. 1A, XR device 102 of FIG. 1A, companion device 104 of FIG. 1A, XR system 200 of FIG. 2, XR system 300 of FIG. 3, XR device 302 of FIG. 3, companion device 322 of FIG. 3, or another system or device.

The components of computing-device architecture 900 are shown in electrical communication with each other using connection 912, such as a bus. The example computing-device architecture 900 includes a processing unit (CPU or processor) 902 and computing device connection 912 that couples various computing device components including computing device memory 910, such as read only memory (ROM) 908 and random-access memory (RAM) 906, to processor 902.

Computing-device architecture 900 can include a cache of high-speed memory connected directly with, in close proximity to, or integrated as part of processor 902. Computing-device architecture 900 can copy data from memory 910 and/or the storage device 914 to cache 904 for quick access by processor 902. In this way, the cache can provide a performance boost that avoids processor 902 delays while waiting for data. These and other engines can control or be configured to control processor 902 to perform various actions. Other computing device memory 910 may be available for use as well. Memory 910 can include multiple different types of memory with different performance characteristics. Processor 902 can include any general-purpose processor and a hardware or software service, such as service 1 916, service 2 918, and service 3 920 stored in storage device 914, configured to control processor 902 as well as a special-purpose processor where software instructions are incorporated into the processor design. Processor 902 may be a self-contained system, containing multiple cores or processors, a bus, memory controller, cache, etc. A multi-core processor may be symmetric or asymmetric.

To enable user interaction with the computing-device architecture 900, input device 922 can represent any number of input mechanisms, such as a microphone for speech, a touch-sensitive screen for gesture or graphical input, keyboard, mouse, motion input, speech and so forth. Output device 924 can also be one or more of a number of output mechanisms known to those of skill in the art, such as a display, projector, television, speaker device, etc. In some examples, multimodal computing devices can enable a user to provide multiple types of input to communicate with computing-device architecture 900. Communication interface 926 can generally govern and manage the user input and computing device output. There is no restriction on operating on any particular hardware arrangement and therefore the basic features here may easily be substituted for improved hardware or firmware arrangements as they are developed.

Storage device 914 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 906, read only memory (ROM) 908, and hybrids thereof. Storage device 914 can include services 916, 918, and 920 for controlling processor 902. Other hardware or software engines or modules are contemplated. Storage device 914 can be connected to the computing device connection 912. In one aspect, a hardware engine or module that performs a particular function can include the software component stored in a computer-readable medium in connection with the necessary hardware components, such as processor 902, connection 912, output device 924, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some examples the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other examples, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus configured to process image data, the apparatus comprising: at least one memory; and at least one processor coupled to the at least one memory, the at least one processor being configured to: determine estimated transmission power information associated with a channel between the apparatus and a computing device; obtain one or more extended reality (XR) application parameters associated with an XR application corresponding to one or more of the apparatus or the computing device; and determine, based on the estimated transmission power information and the one or more XR application parameters, a split perception configuration for balancing a perception workload of the XR application between the apparatus and the computing device.

Aspect 2. The apparatus of Aspect 1, wherein: the estimated transmission power information is indicative of an estimated power associated with transmitting encoded image data from an XR device to a companion device; and to determine the split perception configuration, the at least one processor is configured to compare the estimated power to a second estimated power associated with processing the perception workload by the XR device.

Aspect 3. The apparatus of Aspect 2, wherein the second estimated power associated with processing the perception workload by the XR device is based on the one or more XR application parameters.

Aspect 4. The apparatus of any of Aspects 2 to 3, wherein the estimated transmission power information is further indicative of an estimated power associated with encoding image data by the XR device.

Aspect 5. The apparatus of any of Aspects 2 to 4, wherein: the apparatus comprises the XR device; and the computing device comprises the companion device.

Aspect 6. The apparatus of any of Aspects 2 to 5, wherein: the apparatus comprises the companion device, and the computing device comprises the XR device.

Aspect 7. The apparatus of any of Aspects 1 to 6, wherein: the split perception configuration is selected from a plurality of split perception configurations; and each respective split perception configuration of the plurality of split perception configurations is indicative of a respective subset of perception workload tasks performed by the apparatus and a respective subset of perception workload tasks performed by the computing device.

Aspect 8. The apparatus of Aspect 7, wherein the split perception configuration is indicative of a selection between the apparatus and the computing device for performing one or more perception workload tasks, the one or more perception workload tasks including one or more of hand tracking, head tracking, plane finding, image tracking, body tracking, or three-dimensional reconstruction.

Aspect 9. The apparatus of any of Aspects 7 to 8, wherein the plurality of split perception configurations includes at least a first split perception configuration associated with clear channel conditions between the apparatus and the computing device and a second split perception configuration associated with poor channel conditions between the apparatus and the computing device.

Aspect 10. The apparatus of Aspect 9, wherein: a quantity of perception workload tasks offloaded from the apparatus to the computing device is greater in the first split perception configuration than in the second split perception configuration; and a quantity of perception workload tasks performed by the apparatus is smaller in the first split perception configuration than in the second split perception configuration.

Aspect 11. The apparatus of Aspect 10, wherein the plurality of split perception configurations includes at least one split perception configuration corresponding to no perception workload tasks being offloaded from the apparatus to the computing device.

Aspect 12. The apparatus of any of Aspects 1 to 11, wherein the estimated transmission power information is based on channel condition information corresponding to the channel between the apparatus and the computing device.

Aspect 13. The apparatus of Aspect 12, wherein the channel condition information comprises WiFi channel condition information.

Aspect 14. The apparatus of Aspect 13, wherein, to determine the estimated transmission power information, the at least one processor is configured to perform WiFi power modeling based on the WiFi channel condition information.

Aspect 15. The apparatus of any of Aspects 12 to 15, wherein the channel condition information is indicative of a modulation coding scheme (MCS) associated with transmissions on the channel.

Aspect 16. An apparatus configured to process image data, the apparatus comprising: at least one memory; and at least one processor coupled to the at least one memory, the at least one processor being configured to: determine channel condition information associated with a channel between the apparatus and a computing device; obtain one or more extended reality (XR) application parameters associated with an XR application corresponding to one or more of the apparatus or the computing device; and determine, based on the channel condition information and the one or more XR application parameters, a render mode configuration for balancing a render workload of the XR application between the apparatus and the computing device.

Aspect 17. The apparatus of Aspect 16, wherein the render mode configuration is selected from a plurality of render mode configurations, each respective render mode configuration of the plurality of render mode configurations corresponding to a respective channel condition state.

Aspect 18. The apparatus of Aspect 17, wherein the plurality of render mode configurations includes: a first render mode configuration associated with a clear channel condition state indicated by channel condition information; and a second render mode configuration associated with a moderate channel condition state indicated by channel condition information.

Aspect 19. The apparatus of Aspect 18, wherein, in the first render mode configuration, the at least one processor is configured to: transmit, to the computing device, encoded image data obtained from one or more cameras of the apparatus; receive, from the computing device, a rendered eyebuffer associated with one or more world-locked layers and one or more rendered head-locked layers, the rendered eyebuffer based on the encoded image data; and perform reprojection of the rendered eyebuffer.

Aspect 20. The apparatus of Aspect 19, wherein the reprojection is a late-stage reprojection (LSR) or warping of the rendered eyebuffer based on head pose information determined by the apparatus.

Aspect 21. The apparatus of any of Aspects 18 to 20, wherein, in the second render mode configuration, the at least one processor is configured to: transmit, to the computing device, encoded image data obtained from one or more cameras of the apparatus; render one or more head-locked layers based on the image data; receive, from the computing device, a rendered eyebuffer associated with one or more world-locked layers; and combine the one or more head-locked layers with the rendered eyebuffer.

Aspect 22. The apparatus of any of Aspects 18 to 21, wherein the plurality of render mode configurations further includes a third render mode configuration associated with a poor channel condition state indicated by channel condition information, and wherein, in the third render mode configuration, the at least one processor is configured to: transmit, to the computing device, encoded image data obtained from one or more cameras of the apparatus; render one or more head-locked layers based on the image data; receive, from the computing device, a downscaled rendered eyebuffer associated with one or more downscaled world-locked layers; upscale the one or more downscaled world-locked layers; and combine the one or more head-locked layers with the one or more upscaled world-locked layers.

Aspect 23. The apparatus of any of Aspects 16 to 22, wherein: the apparatus comprises an XR device; and the computing device comprises a companion device.

Aspect 24. The apparatus of any of Aspects 16 to 23, wherein: the apparatus comprises a companion device; and the computing device comprises an XR device.

Aspect 25. The apparatus of any of Aspects 16 to 24, wherein the channel condition information comprises WiFi channel condition information.

Aspect 26. The apparatus of any of Aspects 16 to 25, wherein the channel condition information is indicative of a modulation coding scheme (MCS) associated with transmissions on the channel.

Aspect 27. A method for processing image data, the method comprising: determining estimated transmission power information associated with a channel between an extended reality (XR) device and a companion device of the XR device, wherein the XR device and the companion device are included in a split-architecture XR system; obtaining one or more XR application parameters associated with an XR application corresponding to one or more of the XR device or the companion device; and determining, based on the estimated transmission power information and the one or more XR application parameters, a split perception configuration for balancing a perception workload of the XR application between the XR device and the companion device.

Aspect 28. The method of Aspect 27, wherein: the estimated transmission power information is indicative of an estimated power associated with transmitting encoded image data from the XR device to the companion device; and determining the split perception configuration is based on comparing the estimated power to a second estimated power associated with processing the perception workload by the XR device.

Aspect 29. The method of Aspect 28, wherein the second estimated power associated with processing the perception workload by the XR device is based on the one or more XR application parameters.

Aspect 30. The method of any of Aspects 28 to 29, wherein the estimated transmission power information is further indicative of an estimated power associated with encoding image data by the XR device.

Aspect 31. The method of any of Aspects 27 to 30, wherein: the split perception configuration is selected from a plurality of split perception configurations; and each respective split perception configuration of the plurality of split perception configurations is indicative of a respective subset of perception workload tasks performed by the XR device and a respective subset of perception workload tasks performed by the companion device.

Aspect 32. The method of Aspect 31, wherein the split perception configuration is indicative of a selection between the XR device and the companion device for performing one or more perception workload tasks, the one or more perception workload tasks including one or more of hand tracking, head tracking, plane finding, image tracking, body tracking, or three-dimensional reconstruction.

Aspect 33. The method of any of Aspects 31 to 32, wherein the plurality of split perception configurations includes at least a first split perception configuration associated with clear channel conditions between the XR device and the companion device and a second split perception configuration associated with poor channel conditions between the XR device and the companion device.

Aspect 34. The method of Aspect 33, wherein: a quantity of perception workload tasks offloaded from the XR device to the companion device is greater in the first split perception configuration than in the second split perception configuration; and a quantity of perception workload tasks performed by the XR device is smaller in the first split perception configuration than in the second split perception configuration.

Aspect 35. The method of Aspect 34, wherein the plurality of split perception configurations includes at least one split perception configuration corresponding to no perception workload tasks being offloaded from the XR device to the companion device.

Aspect 36. The method of any of Aspects 27 to 35, wherein the estimated transmission power information is based on channel condition information corresponding to the channel between the XR device and the companion device.

Aspect 37. The method of Aspect 36, wherein the channel condition information comprises WiFi channel condition information.

Aspect 38. The method of Aspect 37, wherein determining the estimated transmission power information includes performing WiFi power modeling based on the WiFi channel condition information.

Aspect 39. The method of any of Aspects 36 to 38, wherein the channel condition information is indicative of a modulation coding scheme (MCS) associated with transmissions on the channel.

Aspect 40. A method for processing image data, the method comprising: determining channel condition information associated with a channel between an extended reality (XR) device and a companion device of the XR device, wherein the XR device and the companion device are included in a split-architecture XR system; obtaining one or more XR application parameters associated with an XR application corresponding to one or more of the XR device or the companion device; and determining, based on the channel condition information and the one or more XR application parameters, a render mode configuration for balancing a render workload of the XR application between the XR device and the companion device.

Aspect 41. The method of Aspect 40, wherein the render mode configuration is selected from a plurality of render mode configurations, each respective render mode configuration of the plurality of render mode configurations corresponding to a respective channel condition state.

Aspect 42. The method of Aspect 41, wherein the plurality of render mode configurations includes: a first render mode configuration associated with a clear channel condition state indicated by channel condition information; and a second render mode configuration associated with a moderate channel condition state indicated by channel condition information.

Aspect 43. The method of Aspect 42, further comprising, in response to the first render mode configuration: transmitting, to the companion device, encoded image data obtained from one or more cameras of the XR device; receiving, from the companion device, a rendered eyebuffer associated with one or more world-locked layers and one or more rendered head-locked layers, the rendered eyebuffer based on the encoded image data; and performing reprojection of the rendered eyebuffer.

Aspect 44. The method of Aspect 43, wherein the reprojection is a late-stage reprojection (LSR) or warping of the rendered eyebuffer based on head pose information determined by the XR device.

Aspect 45. The method of any of Aspects 42 to 44, further comprising, in response to the second render mode configuration: transmitting, to the companion device, encoded image data obtained from one or more cameras of the XR device; rendering one or more head-locked layers based on the image data; receiving, from the companion device, a rendered eyebuffer associated with one or more world-locked layers; and combining the one or more head-locked layers with the rendered eyebuffer.

Aspect 46. The method of any of Aspects 42 to 45, wherein the plurality of render mode configurations further includes a third render mode configuration associated with a poor channel condition state indicated by channel condition information, and wherein the method further comprises, in response to the third render mode configuration: transmitting, to the companion device, encoded image data obtained from one or more cameras of the XR device; rendering one or more head-locked layers based on the image data; receiving, from the companion device, a downscaled rendered eyebuffer associated with one or more downscaled world-locked layers; upscaling the one or more downscaled world-locked layers; and combining the one or more head-locked layers with the one or more upscaled world-locked layers.

Aspect 47. The method of any of Aspects 40 to 46, wherein the channel condition information comprises WiFi channel condition information.

Aspect 48. The method of any of Aspects 40 to 47, wherein the channel condition information is indicative of a modulation coding scheme (MCS) associated with transmissions on the channel.

Aspect 49. A non-transitory computer-readable medium storing instructions that, when executed by one or more processors, cause the one or more processors to perform operations according to any of Aspects 1 to 15.

Aspect 50. A non-transitory computer-readable medium storing instructions that, when executed by one or more processors, cause the one or more processors to perform operations according to any of Aspects 16 to 26.

Aspect 51. An apparatus comprising one or more means for performing operations according to any of Aspects 1 to 15.

Aspect 52. An apparatus comprising one or more means for performing operations according to any of Aspects 16 to 26.

Aspect 53. A non-transitory computer-readable medium storing instructions that, when executed by one or more processors, cause the one or more processors to perform operations according to any of Aspects 28 to 39.

Aspect 54. A non-transitory computer-readable medium storing instructions that, when executed by one or more processors, cause the one or more processors to perform operations according to any of Aspects 40 to 48.

Aspect 55. An apparatus comprising one or more means for performing operations according to any of Aspects 28 to 39.

Aspect 56. An apparatus comprising one or more means for performing operations according to any of Aspects 40 to 48.

What is claimed is:

1. An apparatus configured to process image data, the apparatus comprising:
at least one memory; and
at least one processor coupled to the at least one memory, the at least one processor being configured to:
determine estimated transmission power information associated with a channel between the apparatus and a computing device;
obtain one or more extended reality (XR) application parameters associated with an XR application corresponding to one or more of the apparatus or the computing device; and
determine, based on the estimated transmission power information and the one or more XR application parameters, a split perception configuration for balancing a perception workload of the XR application between the apparatus and the computing device.

2. The apparatus of claim 1, wherein:
the estimated transmission power information is indicative of an estimated power associated with transmitting encoded image data from an XR device to a companion device; and
to determine the split perception configuration, the at least one processor is configured to compare the estimated power to a second estimated power associated with processing the perception workload by the XR device.

3. The apparatus of claim 2, wherein the second estimated power associated with processing the perception workload by the XR device is based on the one or more XR application parameters.

4. The apparatus of claim 2, wherein the estimated transmission power information is further indicative of an estimated power associated with encoding image data by the XR device.

5. The apparatus of claim 2, wherein:
the apparatus comprises the XR device; and
the computing device comprises the companion device.

6. The apparatus of claim 2, wherein:
the apparatus comprises the companion device; and
the computing device comprises the XR device.

7. The apparatus of claim 1, wherein:
the split perception configuration is selected from a plurality of split perception configurations; and
each respective split perception configuration of the plurality of split perception configurations is indicative of a respective subset of perception workload tasks performed by the apparatus and a respective subset of perception workload tasks performed by the computing device.

8. The apparatus of claim 7, wherein the split perception configuration is indicative of a selection between the apparatus and the computing device for performing one or more perception workload tasks, the one or more perception workload tasks including one or more of hand tracking, head tracking, plane finding, image tracking, body tracking, or three-dimensional reconstruction.

9. The apparatus of claim 7, wherein the plurality of split perception configurations includes at least a first split perception configuration associated with clear channel conditions between the apparatus and the computing device and a second split perception configuration associated with poor channel conditions between the apparatus and the computing device.

10. The apparatus of claim 9, wherein:
a quantity of perception workload tasks offloaded from the apparatus to the computing device is greater in the first split perception configuration than in the second split perception configuration; and
a quantity of perception workload tasks performed by the apparatus is smaller in the first split perception configuration than in the second split perception configuration.

11. The apparatus of claim 1, wherein the estimated transmission power information is based on channel condition information corresponding to the channel between the apparatus and the computing device, and wherein the channel condition information is indicative of a modulation coding scheme (MCS) associated with transmissions on the channel.

12. A method for processing image data, the method comprising:
determining estimated transmission power information associated with a channel between an extended reality (XR) device and a companion device of the XR device, wherein the XR device and the companion device are included in a split-architecture XR system;
obtaining one or more XR application parameters associated with an XR application corresponding to one or more of the XR device or the companion device; and
determining, based on the estimated transmission power information and the one or more XR application parameters, a split perception configuration for balancing a perception workload of the XR application between the XR device and the companion device.

13. An apparatus configured to process image data, the apparatus comprising:
at least one memory; and
at least one processor coupled to the at least one memory, the at least one processor being configured to:
determine channel condition information associated with a channel between the apparatus and a computing device;
obtain one or more extended reality (XR) application parameters associated with an XR application corresponding to one or more of the apparatus or the computing device; and
determine, based on the channel condition information and the one or more XR application parameters, a render mode configuration for balancing a render workload of the XR application between the apparatus and the computing device.

14. The apparatus of claim 13, wherein the render mode configuration is selected from a plurality of render mode configurations, each respective render mode configuration of the plurality of render mode configurations corresponding to a respective channel condition state.

15. The apparatus of claim 14, wherein the plurality of render mode configurations includes:
a first render mode configuration associated with a clear channel condition state indicated by channel condition information; and
a second render mode configuration associated with a moderate channel condition state indicated by channel condition information.

16. The apparatus of claim 15, wherein, in the first render mode configuration, the at least one processor is configured to:
transmit, to the computing device, encoded image data obtained from one or more cameras of the apparatus;
receive, from the computing device, a rendered eyebuffer associated with one or more world-locked layers and one or more rendered head-locked layers, the rendered eyebuffer based on the encoded image data; and
perform reprojection of the rendered eyebuffer.

17. The apparatus of claim 16, wherein the reprojection is a late-stage reprojection (LSR) or warping of the rendered eyebuffer based on head pose information determined by the apparatus.

18. The apparatus of claim 15, wherein, in the second render mode configuration, the at least one processor is configured to:
transmit, to the computing device, encoded image data obtained from one or more cameras of the apparatus;
render one or more head-locked layers based on the image data;
receive, from the computing device, a rendered eyebuffer associated with one or more world-locked layers; and
combine the one or more head-locked layers with the rendered eyebuffer.

19. The apparatus of claim 15, wherein the plurality of render mode configurations further includes a third render mode configuration associated with a poor channel condition state indicated by channel condition information, and wherein, in the third render mode configuration, the at least one processor is configured to:
transmit, to the computing device, encoded image data obtained from one or more cameras of the apparatus;
render one or more head-locked layers based on the image data;
receive, from the computing device, a downscaled rendered eyebuffer associated with one or more downscaled world-locked layers;
upscale the one or more downscaled world-locked layers; and
combine the one or more head-locked layers with the one or more upscaled world-locked layers.

20. The apparatus of claim 16, wherein:
the apparatus comprises an XR device; and
the computing device comprises a companion device.
